(19) United States
(12) Patent Application Publication
(10) Pub. No.: US 2014/0198846 A1
(43) Pub. Date: Jul. 17, 2014

(54) DEVICE AND METHOD FOR SCALABLE CODING OF VIDEO INFORMATION

(71) Applicant: QUALCOMM Incorporated, San Diego, CA (US)

(72) Inventors: Liwei GUO, San Diego, CA (US); Krishnakanth RAPAKA, San Diego, CA (US); Jianle CHEN, San Diego, CA (US); Xiang LI, San Diego, CA (US); Vadim SEREGIN, San Diego, CA (US); Marta KARCZEWICZ, San Diego, CA (US); Wei PU, San Diego, CA (US)

(73) Assignee: QUALCOMM Incorporated, San Diego, CA (US)

(21) Appl. No.: 14/154,077

(22) Filed: Jan. 13, 2014

Related U.S. Application Data
(60) Provisional application No. 61/753,258, filed on Jan. 16, 2013.
(60) Provisional application No. 61/772,480, filed on Mar. 4, 2013.

(51) Int. Cl. H04N 19/593; H04N 19/33

(52) U.S. Cl. CPC H04N 19/00763; H04N 19/00436
USPC 375/240.12

(57) ABSTRACT

An apparatus configured to code (e.g., encode or decode) video information includes a memory unit and a processor in communication with the memory unit. The memory unit is configured to store video information associated with a base layer and an enhancement layer, the enhancement layer comprising an enhancement layer (EL) block and the base layer comprising a base layer (BL) block that is co-located with the enhancement layer block. The processor is configured to determine predicted pixel information of the EL block by applying a prediction function to pixel information of the BL block, and to determine the EL block using the predicted pixel information. The processor may encode or decode the video information.

### CROSS-REFERENCE TO RELATED APPLICATIONS

This application claims priority to U.S. Provisional No. 61/753,258, filed Jan. 16, 2013, and U.S. Provisional No. 61/772,480, filed Mar. 4, 2013, both of which are hereby incorporated by reference in their entirety.

### TECHNICAL FIELD

This disclosure relates to the field of video coding and compression, particularly to scalable video coding (SVC) or multiview video coding (MVC, 3DV).

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video compression techniques perform spatial (intra-picture) prediction and/or temporal (inter-picture) prediction to reduce or remove redundancy inherent in video sequences. For block-based video coding, a video slice (e.g., a video frame, a portion of a video frame, etc.) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy encoding may be applied to achieve even more compression.

### SUMMARY

Scalable video coding (SVC) refers to video coding in which a base layer (BL), sometimes referred to as a reference layer (RL), and one or more scalable enhancement layers (ELs) are used. In SVC, the base layer can carry video data with a base level of quality. The one or more enhancement layers can carry additional video data to support, for example, higher spatial, temporal, and/or signal-to-noise (SNR) levels. Enhancement layers may be defined relative to a previously encoded layer. For example, a bottom layer may serve as a BL, while a top layer may serve as an EL. Middle layers may serve as either ELs or RLs, or both. For example, a layer in the middle may be an EL for the layers below it, such as the base layer or any intervening enhancement layers, and at the same time serve as a RL for one or more enhancement layers above it. Similarly, in the Multiview or 3D extension of the HEVC standard, there may be multiple views, and information of one view may be utilized to code (e.g., encode or decode) the information of another view (e.g., motion estimation, motion vector prediction and/or other redundancies).

In SVC, a current block in the enhancement layer or another view may be predicted using the pixel information of the base layer. For example, in a coding mode for the enhancement layer called Intra BL mode, the texture (e.g., pixel or sample values) of a current block in the enhancement layer may be predicted using the texture of a co-located block in the base layer. Thus, instead of transmitting the texture of the current block, the video encoder can transmit only the difference (e.g., residue) between the texture of the current block and the texture of the co-located base layer block.

However, a new standard that uses a new color space may be developed, and such new standard and/or color space may be incompatible with existing video devices that are widely used. It may be possible to code the BL using the color space compatible with existing devices, and code the EL using the new color space. However, if the base layer video signal is in a different color space than the enhancement layer video signal, the same color may be represented with different values in the two layers. For example, the same color may have a value (10, 0, 0) in the color space used for the base layer and (5, 5, 5) in another color space used for the enhancement layer. In such a case, if the texture (e.g., pixel or sample values) of the co-located base layer block were to be used in its unaltered form as a predictor for the texture of the enhancement layer block, there would be a large prediction error (e.g., residue), and the compression efficiency will be limited. Therefore, the coding efficiency may be improved by first converting the texture of the co-located base layer block from its own color space to the color space used by the enhancement layer, and then using the converted texture as a predictor for the texture of the enhancement layer block.

The systems, methods and devices of this disclosure each have several innovative aspects, no single one of which is solely responsible for the desirable attributes disclosed herein.

In one embodiment, an apparatus configured to code (e.g., encode or decode) video information includes a memory unit and a processor in communication with the memory unit. The memory unit is configured to store video information associated with a base layer and an enhancement layer, the enhancement layer comprising an enhancement layer (EL) block and the base layer comprising a base layer (BL) block that is co-located with the enhancement layer block. The processor is configured to determine predicted pixel information of the EL block by applying a prediction function to pixel information of the BL block, and to determine the EL block using the predicted pixel information.

In one embodiment, a method of coding video information comprises storing video information associated with a base layer and an enhancement layer, the enhancement layer comprising an enhancement layer (EL) block and the base layer comprising a base layer (BL) block that is co-located with the enhancement layer block. The method further comprises determining predicted pixel information of the EL block by applying a prediction function to pixel information of the BL block, and determining the EL block using the predicted pixel information.

In one embodiment, an apparatus configured to code (e.g., encode or decode) video information includes a memory unit and a processor in communication with the memory unit. The memory unit is configured to store video information associated with a base layer and an enhancement layer. The enhancement layer may comprise an enhancement layer (EL) block and the base layer may comprise a base layer (BL) block that is co-located with the enhancement layer block. The BL block may be represented in a first color space and the EL block may be represented in a second color space different from the first color space. The processor is configured to determine predicted pixel information of the EL block by applying a prediction function to pixel information of the BL block. The prediction function may include one or more prediction parameters that are used to convert the pixel information represented in the first color space to the predicted pixel information represented in the second color space. The process is further configured to determine the EL block using the predicted pixel information.

In one embodiment, a method of coding video information comprises storing video information associated with a base layer and an enhancement layer, the enhancement layer comprising an enhancement layer (EL) block and the base layer comprising a base layer (BL) block that is co-located with the enhancement layer block, wherein the BL block is represented in a first color space and the EL block is represented in a second color space different from the first color space. The method further comprises determining predicted pixel information of the EL block by applying a prediction function to pixel information of the BL block, the prediction function including one or more prediction parameters configured to convert the pixel information represented in the first color space to the predicted pixel information represented in the second color space, and determining the EL block using the predicted pixel information.

### BRIEF DESCRIPTION OF DRAWINGS

FIG. 1 is a block diagram illustrating an example of a video encoding and decoding system that may utilize techniques in accordance with aspects described in this disclosure.

FIG. 2 is a block diagram illustrating an example of a video encoder that may implement techniques in accordance with aspects described in this disclosure.

FIG. 3 is a block diagram illustrating an example of a video decoder that may implement techniques in accordance with aspects described in this disclosure.

FIG. 4 is a conceptual diagram illustrating SVC scalabilities in different dimensions.

FIG. 5 is a conceptual diagram illustrating an example structure of an SVC bitstream.

FIG. 6 is a conceptual diagram illustrating access units in an SVC bitstream.

FIG. 7 is a conceptual diagram illustrating an example of inter-layer prediction, according to one embodiment of the present disclosure.

FIG. 8 is a flow chart illustrating a method of coding video information, according to one embodiment of the present disclosure.

FIG. 9 is a flow chart illustrating a method of coding video information, according to one embodiment of the present disclosure.

### DETAILED DESCRIPTION

Certain embodiments described herein relate to inter-layer prediction for scalable video coding in the context of advanced video codecs, such as HEVC (High Efficiency Video Coding). More specifically, the present disclosure relates to systems and methods for improved performance of inter-layer prediction in scalable video coding (SVC) extension of HEVC.

In the description below, H.264/AVC techniques related to certain embodiments are described; the HEVC standard and related techniques are also discussed. While certain embodiments are described herein in the context of the HEVC and/or H.264 standards, one having ordinary skill in the art may appreciate that systems and methods disclosed herein may be applicable to any suitable video coding standard. For example, embodiments disclosed herein may be applicable to one or more of the following standards: ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

HEVC generally follows the framework of previous video coding standards in many respects. The unit of prediction in HEVC is different from that in certain previous video coding standards (e.g., macroblock). In fact, the concept of macroblock does not exist in HEVC as understood in certain previous video coding standards. Macroblock is replaced by a hierarchical structure based on a quadtree scheme, which may provide high flexibility, among other possible benefits. For example, within the HEVC scheme, three types of blocks, Coding Unit (CU), Prediction Unit (PU), and Transform Unit (TU), are defined. CU may refer to the basic unit of region splitting. CU may be considered analogous to the concept of macroblock, but it does not restrict the maximum size and may allow recursive splitting into four equal size CUs to improve the content adaptivity. PU may be considered the basic unit of inter/intra prediction and it may contain multiple arbitrary shape partitions in a single PU to effectively code irregular image patterns. TU may be considered the basic unit of transform. It can be defined independently from the PU; however, its size may be limited to the CU to which the TU belongs. This separation of the block structure into three different concepts may allow each to be optimized according to its role, which may result in improved coding efficiency.

For purposes of illustration only, certain embodiments disclosed herein are described with examples including only two layers (e.g., lower level layer such as the base layer, and a higher level layer such as the enhancement layer). It should be understood that such examples may be applicable to configurations including multiple base and/or enhancement layers. In addition, for ease of explanation, the following disclosure includes the terms “frames” or “blocks” with reference to certain embodiments. However, these terms are not meant to be limiting. For example, the techniques described below can be used with any suitable video units, such as blocks (e.g., CU, PU, TU, macroblocks, etc.), slices, frames, etc.

### Video Coding Standards

A digital image, such as a video image, a TV image, a still image or an image generated by a video recorder or a computer, may consist of pixels or samples arranged in horizontal and vertical lines. The number of pixels in a single image is typically in the tens of thousands. Each pixel typically contains luminance and chrominance information. Without compression, the quantity of information to be conveyed from an image encoder to an image decoder is so enormous that it renders real-time image transmission impossible. To reduce the amount of information to be transmitted, a number of different compression methods, such as JPEG, MPEG and H.263 standards, have been developed.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

In addition, a new video coding standard, namely High Efficiency Video Coding (HEVC), is being developed by the Joint Collaboration Team on Video Coding (JCT-VC) of ITU-T Video Coding Experts Group (VCEG) and ISO/IEC Motion Picture Experts Group (MPEG). The full citation for the HEVC Draft 10 is document JCTVC-L1003, Bross et al., “High Efficiency Video Coding (HEVC) Text Specification Draft 10,” Joint Collaborative Team on Video Coding (JCT-VC) of ITU-T SG16 WP3 and ISO/IEC JTC1/SC29/WG11, 12th Meeting: Geneva, Switzerland, Jan. 14, 2013 to Jan. 23, 2013.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the present disclosure. For example, an apparatus may be implemented or a method may be practiced using any number of the aspects set forth herein. In addition, the scope of the present disclosure is intended to cover such an apparatus or method which is practiced using other structure, functionality, or structure and functionality in addition to or other than the various aspects of the present disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

### Video Coding System

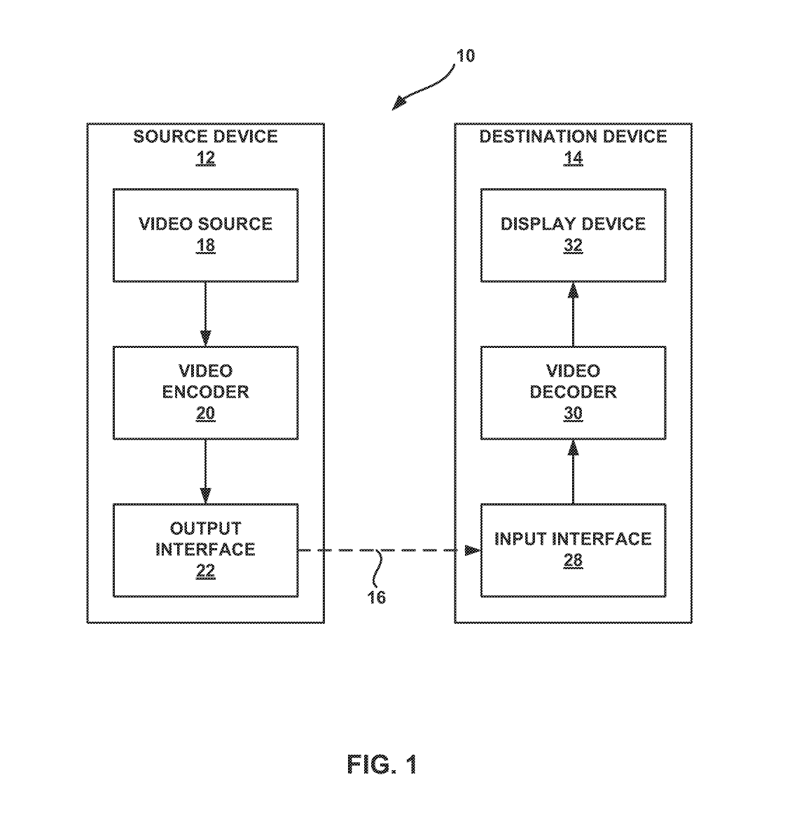

FIG. 1 is a block diagram that illustrates an example video coding system 10 that may utilize techniques in accordance with aspects described in this disclosure. As used described herein, the term “video coder” refers generically to both video encoders and video decoders. In this disclosure, the terms “video coding” or “coding” may refer generically to video encoding and video decoding.

As shown in FIG. 1, video coding system 10 includes a source device 12 and a destination device 14. Source device 12 generates encoded video data. Destination device 14 may decode the encoded video data generated by source device 12. Source device 12 and destination device 14 may comprise a wide range of devices, including desktop computers, notebook (e.g., laptop, etc.) computers, tablet computers, set-top boxes, telephone handsets such as so-called “smart” phones, so-called “smart” pads, televisions, cameras, display devices, digital media players, video gaming consoles, in-car computers, or the like. In some examples, source device 12 and destination device 14 may be equipped for wireless communication.

Destination device 14 may receive encoded video data from source device 12 via a channel 16. Channel 16 may comprise any type of medium or device capable of moving the encoded video data from source device 12 to destination device 14. In one example, channel 16 may comprise a communication medium that enables source device 12 to transmit encoded video data directly to destination device 14 in real-time. In this example, source device 12 may modulate the encoded video data according to a communication standard, such as a wireless communication protocol, and may transmit the modulated video data to destination device 14. The communication medium may comprise a wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or other equipment that facilitates communication from source device 12 to destination device 14.

In another example, channel 16 may correspond to a storage medium that stores the encoded video data generated by source device 12. In this example, destination device 14 may access the storage medium via disk access or card access. The storage medium may include a variety of locally accessed data storage media such as Blu-ray discs, DVDs, CD-ROMs, flash memory, or other suitable digital storage media for storing encoded video data. In a further example, channel 16 may include a file server or another intermediate storage device that stores the encoded video generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website, etc.), FTP servers, network attached storage (NAS) devices, and local disk drives. Destination device 14 may access the encoded video data through any standard data connection, including an Internet connection. Example types of data connections may include wireless channels (e.g., Wi-Fi connections, etc.), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of any of a variety of multimedia applications, such as over-the-air television broadcasts, cable television transmissions, satellite television transmissions, streaming video transmissions, e.g., via the Internet (e.g., dynamic adaptive streaming over HTTP (DASH), etc.), encoding of digital video for storage on a data storage medium, decoding of digital video stored on a data storage medium, or other applications. In some examples, video coding system 10 may be configured to support one-way or two-way video transmission to support applications such as video streaming, video playback, video broadcasting, and/or video telephony.

In the example of FIG. 1, source device 12 includes a video source 18, video encoder 20, and an output interface 22. In some cases, output interface 22 may include a modulator/demodulator (modem) and/or a transmitter. In source device 12, video source 18 may include a source such as a video capture device, e.g., a video camera, a video archive containing previously captured video data, a video feed interface to receive video data from a video content provider, and/or a computer graphics system for generating video data, or a combination of such sources.

Video encoder 20 may be configured to encode the captured, pre-captured, or computer-generated video data. The encoded video data may be transmitted directly to destination device 14 via output interface 22 of source device 12. The encoded video data may also be stored onto a storage medium or a file server for later access by destination device 14 for decoding and/or playback.

In the example of FIG. 1, destination device 14 includes an input interface 28, a video decoder 30, and a display device 32. In some cases, input interface 28 may include a receiver and/or a modem. Input interface 28 of destination device 14 receives encoded video data over channel 16. The encoded video data may include a variety of syntax elements generated by video encoder 20 that represent the video data. The syntax elements may describe characteristics and/or processing of blocks and other coded units, e.g., groups of pictures (GOPs). Such syntax elements may be included with the encoded video data transmitted on a communication medium, stored on a storage medium, or stored a file server.

Display device 32 may be integrated with or may be external to destination device 14. In some examples, destination device 14 may include an integrated display device and may also be configured to interface with an external display device. In other examples, destination device 14 may be a display device. In general, display device 32 displays the decoded video data to a user. Display device 32 may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to a HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in the example of FIG. 1, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Again, FIG. 1 is merely an example and the techniques of this disclosure may apply to video coding settings (e.g., video encoding or video decoding) that do not necessarily include any data communication between the encoding and decoding devices. In other examples, data can be retrieved from a local memory, streamed over a network, or the like. An encoding device may encode and store data to memory, and/or a decoding device may retrieve and decode data from memory. In many examples, the encoding and decoding is performed by devices that do not communicate with one another, but simply encode data to memory and/or retrieve and decode data from memory.

Video encoder 20 and video decoder 30 each may be implemented as any of a variety of suitable circuitry, such as one or more microprocessors, digital signal processors (DSPs), application specific integrated circuits (ASICs), field programmable gate arrays (FPGAs), discrete logic, hardware, or any combinations thereof. When the techniques are implemented partially in software, a device may store instructions for the software in a suitable, non-transitory computer-readable storage medium and may execute the instructions in hardware using one or more processors to perform the techniques of this disclosure. Although video encoder 20 and video decoder 30 are shown as being implemented in separate devices in the example of FIG. 1, the present disclosure is not limited to such configuration, and video encoder 20 and video decoder 30 may be implemented in the same device. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

As mentioned briefly above, video encoder 20 encodes video data. The video data may comprise one or more pictures. Each of the pictures is a still image forming part of a video. In some instances, a picture may be referred to as a video “frame.” When video encoder 20 encodes the video data, video encoder 20 may generate a bitstream. The bitstream may include a sequence of bits that form a coded representation of the video data. The bitstream may include coded pictures and associated data. A coded picture is a coded representation of a picture.

To generate the bitstream, video encoder 20 may perform encoding operations on each picture in the video data. When video encoder 20 performs encoding operations on the pictures, video encoder 20 may generate a series of coded pictures and associated data. The associated data may include video parameter sets (VPS), sequence parameter sets, picture parameter sets, adaptation parameter sets, and other syntax structures. A sequence parameter set (SPS) may contain parameters applicable to zero or more sequences of pictures. A picture parameter set (PPS) may contain parameters applicable to zero or more pictures. An adaptation parameter set (APS) may contain parameters applicable to zero or more pictures. Parameters in an APS may be parameters that are more likely to change than parameters in a PPS.

To generate a coded picture, video encoder 20 may partition a picture into equally-sized video blocks. A video block may be a two-dimensional array of samples. Each of the video blocks is associated with a treeblock. In some instances, a treeblock may be referred to as a largest coding unit (LCU). The treeblocks of HEVC may be broadly analogous to the macroblocks of previous standards, such as H.264/AVC. However, a treeblock is not necessarily limited to a particular size and may include one or more coding units (CUs). Video encoder 20 may use quadtree partitioning to partition the video blocks of treeblocks into video blocks associated with CUs, hence the name “treeblocks.”

In some examples, video encoder 20 may partition a picture into a plurality of slices. Each of the slices may include an integer number of CUs. In some instances, a slice comprises an integer number of treeblocks. In other instances, a boundary of a slice may be within a treeblock.

As part of performing an encoding operation on a picture, video encoder 20 may perform encoding operations on each slice of the picture. When video encoder 20 performs an encoding operation on a slice, video encoder 20 may generate encoded data associated with the slice. The encoded data associated with the slice may be referred to as a “coded slice.”

To generate a coded slice, video encoder 20 may perform encoding operations on each treeblock in a slice. When video encoder 20 performs an encoding operation on a treeblock, video encoder 20 may generate a coded treeblock. The coded treeblock may comprise data representing an encoded version of the treeblock.

When video encoder 20 generates a coded slice, video encoder 20 may perform encoding operations on (e.g., encode) the treeblocks in the slice according to a raster scan order. For example, video encoder 20 may encode the treeblocks of the slice in an order that proceeds from left to right across a topmost row of treeblocks in the slice, then from left to right across a next lower row of treeblocks, and so on until video encoder 20 has encoded each of the treeblocks in the slice.

As a result of encoding the treeblocks according to the raster scan order, the treeblocks above and to the left of a given treeblock may have been encoded, but treeblocks below and to the right of the given treeblock have not yet been encoded. Consequently, video encoder 20 may be able to access information generated by encoding treeblocks above and to the left of the given treeblock when encoding the given treeblock. However, video encoder 20 may be unable to access information generated by encoding treeblocks below and to the right of the given treeblock when encoding the given treeblock.

To generate a coded treeblock, video encoder 20 may recursively perform quadtree partitioning on the video block of the treeblock to divide the video block into progressively smaller video blocks. Each of the smaller video blocks may be associated with a different CU. For example, video encoder 20 may partition the video block of a treeblock into four equally-sized sub-blocks, partition one or more of the sub-blocks into four equally-sized sub-sub-blocks, and so on. A partitioned CU may be a CU whose video block is partitioned into video blocks associated with other CUs. A non-partitioned CU may be a CU whose video block is not partitioned into video blocks associated with other CUs.

One or more syntax elements in the bitstream may indicate a maximum number of times video encoder 20 may partition the video block of a treeblock. A video block of a CU may be square in shape. The size of the video block of a CU (e.g., the size of the CU) may range from 8×8 pixels up to the size of a video block of a treeblock (e.g., the size of the treeblock) with a maximum of 64×64 pixels or greater.

Video encoder 20 may perform encoding operations on (e.g., encode) each CU of a treeblock according to a z-scan order. In other words, video encoder 20 may encode a top-left CU, a top-right CU, a bottom-left CU, and then a bottom-right CU, in that order. When video encoder 20 performs an encoding operation on a partitioned CU, video encoder 20 may encode CUs associated with sub-blocks of the video block of the partitioned CU according to the z-scan order. In other words, video encoder 20 may encode a CU associated with a top-left sub-block, a CU associated with a top-right sub-block, a CU associated with a bottom-left sub-block, and then a CU associated with a bottom-right sub-block, in that order.

As a result of encoding the CUs of a treeblock according to a z-scan order, the CUs above, above-and-to-the-left, above-and-to-the-right, left, and below-and-to-the left of a given CU may have been encoded. CUs below and to the right of the given CU have not yet been encoded. Consequently, video encoder 20 may be able to access information generated by encoding some CUs that neighbor the given CU when encoding the given CU. However, video encoder 20 may be unable to access information generated by encoding other CUs that neighbor the given CU when encoding the given CU.

When video encoder 20 encodes a non-partitioned CU, video encoder 20 may generate one or more prediction units (PUs) for the CU. Each of the PUs of the CU may be associated with a different video block within the video block of the CU. Video encoder 20 may generate a predicted video block for each PU of the CU. The predicted video block of a PU may be a block of samples. Video encoder 20 may use intra prediction or inter prediction to generate the predicted video block for a PU.

When video encoder 20 uses intra prediction to generate the predicted video block of a PU, video encoder 20 may generate the predicted video block of the PU based on decoded samples of the picture associated with the PU. If video encoder 20 uses intra prediction to generate predicted video blocks of the PUs of a CU, the CU is an intra-predicted CU. When video encoder 20 uses inter prediction to generate the predicted video block of the PU, video encoder 20 may generate the predicted video block of the PU based on decoded samples of one or more pictures other than the picture associated with the PU. If video encoder 20 uses inter prediction to generate predicted video blocks of the PUs of a CU, the CU is an inter-predicted CU.

Furthermore, when video encoder 20 uses inter prediction to generate a predicted video block for a PU, video encoder 20 may generate motion information for the PU. The motion information for a PU may indicate one or more reference blocks of the PU. Each reference block of the PU may be a video block within a reference picture. The reference picture may be a picture other than the picture associated with the PU. In some instances, a reference block of a PU may also be referred to as the “reference sample” of the PU. Video encoder 20 may generate the predicted video block for the PU based on the reference blocks of the PU.

After video encoder 20 generates predicted video blocks for one or more PUs of a CU, video encoder 20 may generate residual data for the CU based on the predicted video blocks for the PUs of the CU. The residual data for the CU may indicate differences between samples in the predicted video blocks for the PUs of the CU and the original video block of the CU.

Furthermore, as part of performing an encoding operation on a non-partitioned CU, video encoder 20 may perform recursive quadtree partitioning on the residual data of the CU to partition the residual data of the CU into one or more blocks of residual data (e.g., residual video blocks) associated with transform units (TUs) of the CU. Each TU of a CU may be associated with a different residual video block.

Video coder 20 may apply one or more transforms to residual video blocks associated with the TUs to generate transform coefficient blocks (e.g., blocks of transform coefficients) associated with the TUs. Conceptually, a transform coefficient block may be a two-dimensional (2D) matrix of transform coefficients.

After generating a transform coefficient block, video encoder 20 may perform a quantization process on the transform coefficient block. Quantization generally refers to a process in which transform coefficients are quantized to possibly reduce the amount of data used to represent the transform coefficients, providing further compression. The quantization process may reduce the bit depth associated with some or all of the transform coefficients. For example, an n-bit transform coefficient may be rounded down to an m-bit transform coefficient during quantization, where n is greater than m.

Video encoder 20 may associate each CU with a quantization parameter (QP) value. The QP value associated with a CU may determine how video encoder 20 quantizes transform coefficient blocks associated with the CU. Video encoder 20 may adjust the degree of quantization applied to the transform coefficient blocks associated with a CU by adjusting the QP value associated with the CU.

After video encoder 20 quantizes a transform coefficient block, video encoder 20 may generate sets of syntax elements that represent the transform coefficients in the quantized transform coefficient block. Video encoder 20 may apply entropy encoding operations, such as Context Adaptive Binary Arithmetic Coding (CABAC) operations, to some of these syntax elements. Other entropy coding techniques such as content adaptive variable length coding (CAVLC), probability interval partitioning entropy (PIPE) coding, or other binary arithmetic coding could also be used.

The bitstream generated by video encoder 20 may include a series of Network Abstraction Layer (NAL) units. Each of the NAL units may be a syntax structure containing an indication of a type of data in the NAL unit and bytes containing the data. For example, a NAL unit may contain data representing a video parameter set, a sequence parameter set, a picture parameter set, a coded slice, supplemental enhancement information (SEI), an access unit delimiter, filler data, or another type of data. The data in a NAL unit may include various syntax structures.

Video decoder 30 may receive the bitstream generated by video encoder 20. The bitstream may include a coded representation of the video data encoded by video encoder 20. When video decoder 30 receives the bitstream, video decoder 30 may perform a parsing operation on the bitstream. When video decoder 30 performs the parsing operation, video decoder 30 may extract syntax elements from the bitstream. Video decoder 30 may reconstruct the pictures of the video data based on the syntax elements extracted from the bitstream. The process to reconstruct the video data based on the syntax elements may be generally reciprocal to the process performed by video encoder 20 to generate the syntax elements.

After video decoder 30 extracts the syntax elements associated with a CU, video decoder 30 may generate predicted video blocks for the PUs of the CU based on the syntax elements. In addition, video decoder 30 may inverse quantize transform coefficient blocks associated with TUs of the CU. Video decoder 30 may perform inverse transforms on the transform coefficient blocks to reconstruct residual video blocks associated with the TUs of the CU. After generating the predicted video blocks and reconstructing the residual video blocks, video decoder 30 may reconstruct the video block of the CU based on the predicted video blocks and the residual video blocks. In this way, video decoder 30 may reconstruct the video blocks of CUs based on the syntax elements in the bitstream.

### Video Encoder

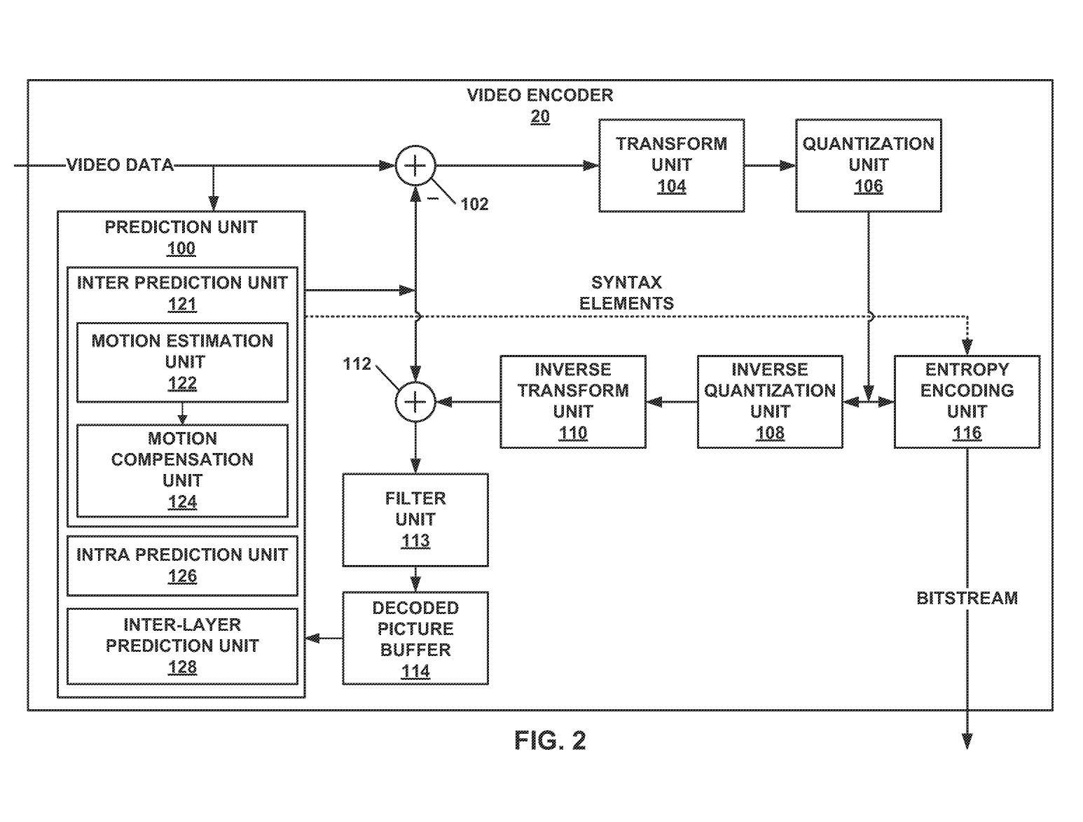

FIG. 2 is a block diagram illustrating an example of a video encoder that may implement techniques in accordance with aspects described in this disclosure. Video encoder 20 may be configured to perform any or all of the techniques of this disclosure. As one example, prediction unit 100 may be configured to perform any or all of the techniques described in this disclosure. In another embodiment, the video encoder 20 includes an optional inter-layer prediction unit 128 that is configured to perform any or all of the techniques described in this disclosure. In other embodiments, inter-layer prediction can be performed by prediction unit 100 (e.g., inter prediction unit 121 and/or intra prediction unit 126), in which case the inter-layer prediction unit 128 may be omitted. However, aspects of this disclosure are not so limited. In some examples, the techniques described in this disclosure may be shared among the various components of video encoder 20. In some examples, in addition to or instead of, a processor (not shown) may be configured to perform any or all of the techniques described in this disclosure.

For purposes of explanation, this disclosure describes video encoder 20 in the context of HEVC coding. However, the techniques of this disclosure may be applicable to other coding standards or methods.

Video encoder 20 may perform intra- and inter-coding of video blocks within video slices. Intra coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-directional prediction (B mode), may refer to any of several temporal-based coding modes.

In the example of FIG. 2, video encoder 20 includes a plurality of functional components. The functional components of video encoder 20 include a prediction unit 100, a residual generation unit 102, a transform unit 104, a quantization unit 106, an inverse quantization unit 108, an inverse transform unit 110, a reconstruction unit 112, a filter unit 113, a decoded picture buffer 114, and an entropy encoding unit 116. Prediction unit 100 includes an inter prediction unit 121, a motion estimation unit 122, a motion compensation unit 124, an intra prediction unit 126, and an inter-layer prediction unit 128. In other examples, video encoder 20 may include more, fewer, or different functional components. Furthermore, motion estimation unit 122 and motion compensation unit 124 may be highly integrated, but are represented in the example of FIG. 2 separately for purposes of explanation.

Video encoder 20 may receive video data. Video encoder 20 may receive the video data from various sources. For example, video encoder 20 may receive the video data from video source 18 (FIG. 1) or another source. The video data may represent a series of pictures. To encode the video data, video encoder 20 may perform an encoding operation on each of the pictures. As part of performing the encoding operation on a picture, video encoder 20 may perform encoding operations on each slice of the picture. As part of performing an encoding operation on a slice, video encoder 20 may perform encoding operations on treeblocks in the slice.

As part of performing an encoding operation on a treeblock, prediction unit 100 may perform quadtree partitioning on the video block of the treeblock to divide the video block into progressively smaller video blocks. Each of the smaller video blocks may be associated with a different CU. For example, prediction unit 100 may partition a video block of a treeblock into four equally-sized sub-blocks, partition one or more of the sub-blocks into four equally-sized sub-sub-blocks, and so on.

The sizes of the video blocks associated with CUs may range from 8×8 samples up to the size of the treeblock with a maximum of 64×64 samples or greater. In this disclosure, “N×N” and “N by N” may be used interchangeably to refer to the sample dimensions of a video block in terms of vertical and horizontal dimensions, e.g., 16×16 samples or 16 by 16 samples. In general, a 16×16 video block has sixteen samples in a vertical direction (y=16) and sixteen samples in a horizontal direction (x=16). Likewise, an N×N block generally has N samples in a vertical direction and N samples in a horizontal direction, where N represents a nonnegative integer value.

Furthermore, as part of performing the encoding operation on a treeblock, prediction unit 100 may generate a hierarchical quadtree data structure for the treeblock. For example, a treeblock may correspond to a root node of the quadtree data structure. If prediction unit 100 partitions the video block of the treeblock into four sub-blocks, the root node has four child nodes in the quadtree data structure. Each of the child nodes corresponds to a CU associated with one of the sub-blocks. If prediction unit 100 partitions one of the sub-blocks into four sub-sub-blocks, the node corresponding to the CU associated with the sub-block may have four child nodes, each of which corresponds to a CU associated with one of the sub-sub-blocks.

Each node of the quadtree data structure may contain syntax data (e.g., syntax elements) for the corresponding treeblock or CU. For example, a node in the quadtree may include a split flag that indicates whether the video block of the CU corresponding to the node is partitioned (e.g., split) into four sub-blocks. Syntax elements for a CU may be defined recursively, and may depend on whether the video block of the CU is split into sub-blocks. A CU whose video block is not partitioned may correspond to a leaf node in the quadtree data structure. A coded treeblock may include data based on the quadtree data structure for a corresponding treeblock.

Video encoder 20 may perform encoding operations on each non-partitioned CU of a treeblock. When video encoder 20 performs an encoding operation on a non-partitioned CU, video encoder 20 generates data representing an encoded representation of the non-partitioned CU.

As part of performing an encoding operation on a CU, prediction unit 100 may partition the video block of the CU among one or more PUs of the CU. Video encoder 20 and video decoder 30 may support various PU sizes. Assuming that the size of a particular CU is 2N×2N, video encoder 20 and video decoder 30 may support PU sizes of 2N×2N or N×N, and inter-prediction in symmetric PU sizes of 2N×2N, 2N×N, N×2N, N×N, 2N×nU, nL×2N, nR×2N, or similar. Video encoder 20 and video decoder 30 may also support asymmetric partitioning for PU sizes of 2N×nU, 2N×nD, nL×2N, and nR×2N. In some examples, prediction unit 100 may perform geometric partitioning to partition the video block of a CU among PUs of the CU along a boundary that does not meet the sides of the video block of the CU at right angles.

Inter prediction unit 121 may perform inter prediction on each PU of the CU. Inter prediction may provide temporal compression. To perform inter prediction on a PU, motion estimation unit 122 may generate motion information for the PU. Motion compensation unit 124 may generate a predicted video block for the PU based the motion information and decoded samples of pictures other than the picture associated with the CU (e.g., reference pictures). In this disclosure, a predicted video block generated by motion compensation unit 124 may be referred to as an inter-predicted video block.

Slices may be I slices, P slices, or B slices. Motion estimation unit 122 and motion compensation unit 124 may perform different operations for a PU of a CU depending on whether the PU is in an I slice, a P slice, or a B slice. In an I slice, all PUs are intra predicted. Hence, if the PU is in an I slice, motion estimation unit 122 and motion compensation unit 124 do not perform inter prediction on the PU.

If the PU is in a P slice, the picture containing the PU is associated with a list of reference pictures referred to as “list 0.” Each of the reference pictures in list 0 contains samples that may be used for inter prediction of other pictures. When motion estimation unit 122 performs the motion estimation operation with regard to a PU in a P slice, motion estimation unit 122 may search the reference pictures in list 0 for a reference block for the PU. The reference block of the PU may be a set of samples, e.g., a block of samples, that most closely corresponds to the samples in the video block of the PU. Motion estimation unit 122 may use a variety of metrics to determine how closely a set of samples in a reference picture corresponds to the samples in the video block of a PU. For example, motion estimation unit 122 may determine how closely a set of samples in a reference picture corresponds to the samples in the video block of a PU by sum of absolute difference (SAD), sum of square difference (SSD), or other difference metrics.

After identifying a reference block of a PU in a P slice, motion estimation unit 122 may generate a reference index that indicates the reference picture in list 0 containing the reference block and a motion vector that indicates a spatial displacement between the PU and the reference block. In various examples, motion estimation unit 122 may generate motion vectors to varying degrees of precision. For example, motion estimation unit 122 may generate motion vectors at one-quarter sample precision, one-eighth sample precision, or other fractional sample precision. In the case of fractional sample precision, reference block values may be interpolated from integer-position sample values in the reference picture. Motion estimation unit 122 may output the reference index and the motion vector as the motion information of the PU. Motion compensation unit 124 may generate a predicted video block of the PU based on the reference block identified by the motion information of the PU.

If the PU is in a B slice, the picture containing the PU may be associated with two lists of reference pictures, referred to as “list 0” and “list 1.” In some examples, a picture containing a B slice may be associated with a list combination that is a combination of list 0 and list 1.

Furthermore, if the PU is in a B slice, motion estimation unit 122 may perform uni-directional prediction or bi-directional prediction for the PU. When motion estimation unit 122 performs uni-directional prediction for the PU, motion estimation unit 122 may search the reference pictures of list 0 or list 1 for a reference block for the PU. Motion estimation unit 122 may then generate a reference index that indicates the reference picture in list 0 or list 1 that contains the reference block and a motion vector that indicates a spatial displacement between the PU and the reference block. Motion estimation unit 122 may output the reference index, a prediction direction indicator, and the motion vector as the motion information of the PU. The prediction direction indicator may indicate whether the reference index indicates a reference picture in list 0 or list 1. Motion compensation unit 124 may generate the predicted video block of the PU based on the reference block indicated by the motion information of the PU.

When motion estimation unit 122 performs bi-directional prediction for a PU, motion estimation unit 122 may search the reference pictures in list 0 for a reference block for the PU and may also search the reference pictures in list 1 for another reference block for the PU. Motion estimation unit 122 may then generate reference indexes that indicate the reference pictures in list 0 and list 1 containing the reference blocks and motion vectors that indicate spatial displacements between the reference blocks and the PU. Motion estimation unit 122 may output the reference indexes and the motion vectors of the PU as the motion information of the PU. Motion compensation unit 124 may generate the predicted video block of the PU based on the reference blocks indicated by the motion information of the PU.

In some instances, motion estimation unit 122 does not output a full set of motion information for a PU to entropy encoding unit 116. Rather, motion estimation unit 122 may signal the motion information of a PU with reference to the motion information of another PU. For example, motion estimation unit 122 may determine that the motion information of the PU is sufficiently similar to the motion information of a neighboring PU. In this example, motion estimation unit 122 may indicate, in a syntax structure associated with the PU, a value that indicates to video decoder 30 that the PU has the same motion information as the neighboring PU. In another example, motion estimation unit 122 may identify, in a syntax structure associated with the PU, a neighboring PU and a motion vector difference (MVD). The motion vector difference indicates a difference between the motion vector of the PU and the motion vector of the indicated neighboring PU. Video decoder 30 may use the motion vector of the indicated neighboring PU and the motion vector difference to determine the motion vector of the PU. By referring to the motion information of a first PU when signaling the motion information of a second PU, video encoder 20 may be able to signal the motion information of the second PU using fewer bits.

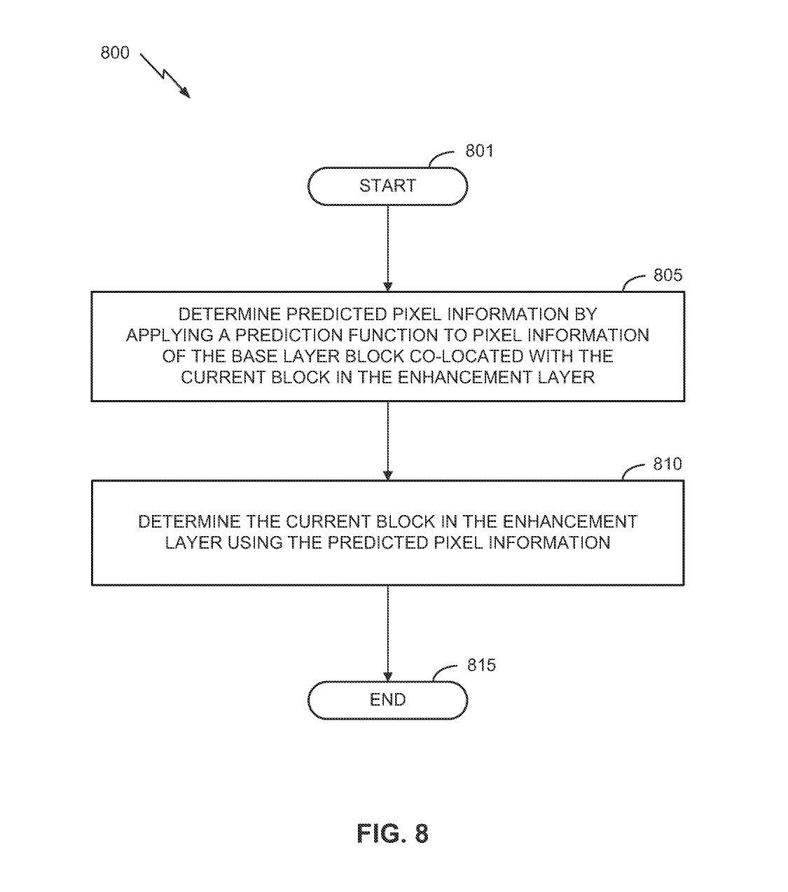

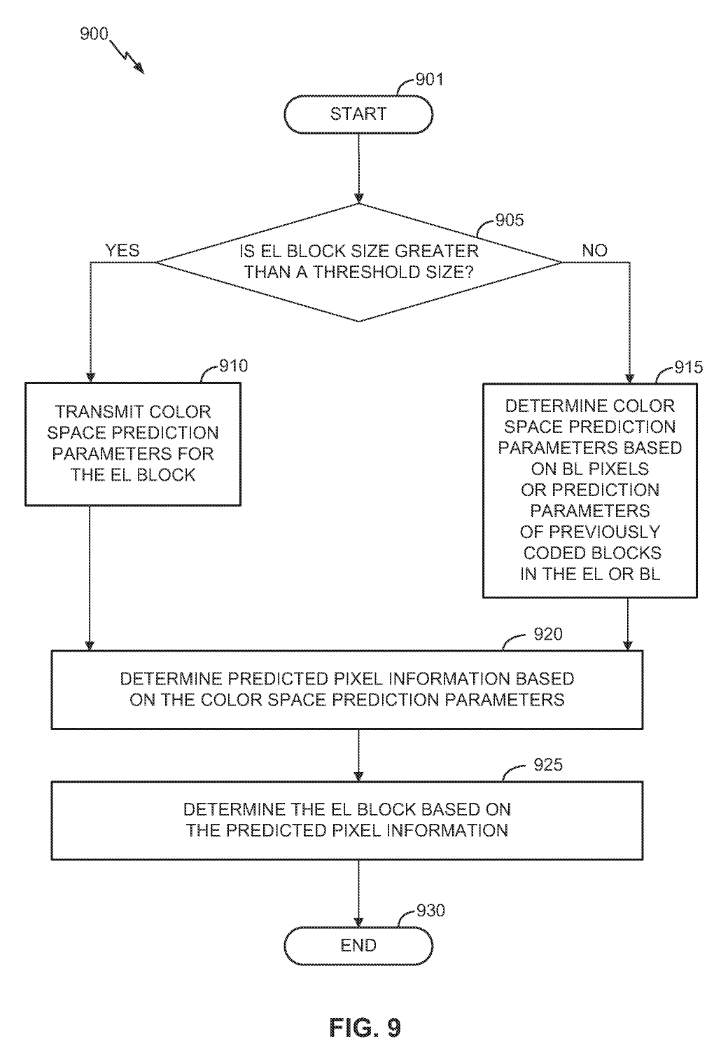

As further discussed below with reference to FIGS. 8 and 9, the prediction unit 100 may be configured to code (e.g., encode or decode) the PU (or any other enhancement layer blocks or video units) by performing the methods illustrated in FIGS. 8 and 9. For example, inter prediction unit 121 (e.g., via motion estimation unit 122 and/or motion compensation unit 124), intra prediction unit 126, or inter-layer prediction unit 128 may be configured to perform the methods illustrated in FIGS. 8 and 9, either together or separately.

As part of performing an encoding operation on a CU, intra prediction unit 126 may perform intra prediction on PUs of the CU. Intra prediction may provide spatial compression. When intra prediction unit 126 performs intra prediction on a PU, intra prediction unit 126 may generate prediction data for the PU based on decoded samples of other PUs in the same picture. The prediction data for the PU may include a predicted video block and various syntax elements. Intra prediction unit 126 may perform intra prediction on PUs in I slices, P slices, and B slices.

To perform intra prediction on a PU, intra prediction unit 126 may use multiple intra prediction modes to generate multiple sets of prediction data for the PU. When intra prediction unit 126 uses an intra prediction mode to generate a set of prediction data for the PU, intra prediction unit 126 may extend samples from video blocks of neighboring PUs across the video block of the PU in a direction and/or gradient associated with the intra prediction mode. The neighboring PUs may be above, above and to the right, above and to the left, or to the left of the PU, assuming a left-to-right, top-to-bottom encoding order for PUs, CUs, and treeblocks. Intra prediction unit 126 may use various numbers of intra prediction modes, e.g., 33 directional intra prediction modes, depending on the size of the PU.

Prediction unit 100 may select the prediction data for a PU from among the prediction data generated by motion compensation unit 124 for the PU or the prediction data generated by intra prediction unit 126 for the PU. In some examples, prediction unit 100 selects the prediction data for the PU based on rate/distortion metrics of the sets of prediction data.

If prediction unit 100 selects prediction data generated by intra prediction unit 126, prediction unit 100 may signal the intra prediction mode that was used to generate the prediction data for the PUs, e.g., the selected intra prediction mode. Prediction unit 100 may signal the selected intra prediction mode in various ways. For example, it is probable the selected intra prediction mode is the same as the intra prediction mode of a neighboring PU. In other words, the intra prediction mode of the neighboring PU may be the most probable mode for the current PU. Thus, prediction unit 100 may generate a syntax element to indicate that the selected intra prediction mode is the same as the intra prediction mode of the neighboring PU.

As discussed above, the video encoder 20 may include inter-layer prediction unit 128. Inter-layer prediction unit 128 is configured to predict a current block (e.g., a current block in the EL) using one or more different layers that are available in SVC (e.g., a base or reference layer). Such prediction may be referred to as inter-layer prediction. Inter-layer prediction unit 128 utilizes prediction methods to reduce inter-layer redundancy, thereby improving coding efficiency and reducing computational resource requirements. Some examples of inter-layer prediction include inter-layer intra prediction, inter-layer motion prediction, and inter-layer residual prediction. Inter-layer intra prediction uses the reconstruction of co-located blocks in the base layer to predict the current block in the enhancement layer. Inter-layer motion prediction uses motion information of the base layer to predict motion in the enhancement layer. Inter-layer residual prediction uses the residue of the base layer to predict the residue of the enhancement layer. Each of the inter-layer prediction schemes is discussed below in greater detail.

After prediction unit 100 selects the prediction data for PUs of a CU, residual generation unit 102 may generate residual data for the CU by subtracting (e.g., indicated by the minus sign) the predicted video blocks of the PUs of the CU from the video block of the CU. The residual data of a CU may include 2D residual video blocks that correspond to different sample components of the samples in the video block of the CU. For example, the residual data may include a residual video block that corresponds to differences between luminance components of samples in the predicted video blocks of the PUs of the CU and luminance components of samples in the original video block of the CU. In addition, the residual data of the CU may include residual video blocks that correspond to the differences between chrominance components of samples in the predicted video blocks of the PUs of the CU and the chrominance components of the samples in the original video block of the CU.

Prediction unit 100 may perform quadtree partitioning to partition the residual video blocks of a CU into sub-blocks. Each undivided residual video block may be associated with a different TU of the CU. The sizes and positions of the residual video blocks associated with TUs of a CU may or may not be based on the sizes and positions of video blocks associated with the PUs of the CU. A quadtree structure known as a “residual quad tree” (RQT) may include nodes associated with each of the residual video blocks. The TUs of a CU may correspond to leaf nodes of the RQT.

Transform unit 104 may generate one or more transform coefficient blocks for each TU of a CU by applying one or more transforms to a residual video block associated with the TU. Each of the transform coefficient blocks may be a 2D matrix of transform coefficients. Transform unit 104 may apply various transforms to the residual video block associated with a TU. For example, transform unit 104 may apply a discrete cosine transform (DCT), a directional transform, or a conceptually similar transform to the residual video block associated with a TU.

After transform unit 104 generates a transform coefficient block associated with a TU, quantization unit 106 may quantize the transform coefficients in the transform coefficient block. Quantization unit 106 may quantize a transform coefficient block associated with a TU of a CU based on a QP value associated with the CU.

Video encoder 20 may associate a QP value with a CU in various ways. For example, video encoder 20 may perform a rate-distortion analysis on a treeblock associated with the CU. In the rate-distortion analysis, video encoder 20 may generate multiple coded representations of the treeblock by performing an encoding operation multiple times on the treeblock. Video encoder 20 may associate different QP values with the CU when video encoder 20 generates different encoded representations of the treeblock. Video encoder 20 may signal that a given QP value is associated with the CU when the given QP value is associated with the CU in a coded representation of the treeblock that has a lowest bitrate and distortion metric.

Inverse quantization unit 108 and inverse transform unit 110 may apply inverse quantization and inverse transforms to the transform coefficient block, respectively, to reconstruct a residual video block from the transform coefficient block. Reconstruction unit 112 may add the reconstructed residual video block to corresponding samples from one or more predicted video blocks generated by prediction unit 100 to produce a reconstructed video block associated with a TU. By reconstructing video blocks for each TU of a CU in this way, video encoder 20 may reconstruct the video block of the CU.

After reconstruction unit 112 reconstructs the video block of a CU, filter unit 113 may perform a deblocking operation to reduce blocking artifacts in the video block associated with the CU. After performing the one or more deblocking operations, filter unit 113 may store the reconstructed video block of the CU in decoded picture buffer 114. Motion estimation unit 122 and motion compensation unit 124 may use a reference picture that contains the reconstructed video block to perform inter prediction on PUs of subsequent pictures. In addition, intra prediction unit 126 may use reconstructed video blocks in decoded picture buffer 114 to perform intra prediction on other PUs in the same picture as the CU.

Entropy encoding unit 116 may receive data from other functional components of video encoder 20. For example, entropy encoding unit 116 may receive transform coefficient blocks from quantization unit 106 and may receive syntax elements from prediction unit 100. When entropy encoding unit 116 receives the data, entropy encoding unit 116 may perform one or more entropy encoding operations to generate entropy encoded data. For example, video encoder 20 may perform a context adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, or another type of entropy encoding operation on the data. Entropy encoding unit 116 may output a bitstream that includes the entropy encoded data.

As part of performing an entropy encoding operation on data, entropy encoding unit 116 may select a context model. If entropy encoding unit 116 is performing a CABAC operation, the context model may indicate estimates of probabilities of particular bins having particular values. In the context of CABAC, the term “bin” is used to refer to a bit of a binarized version of a syntax element.

### Video Decoder

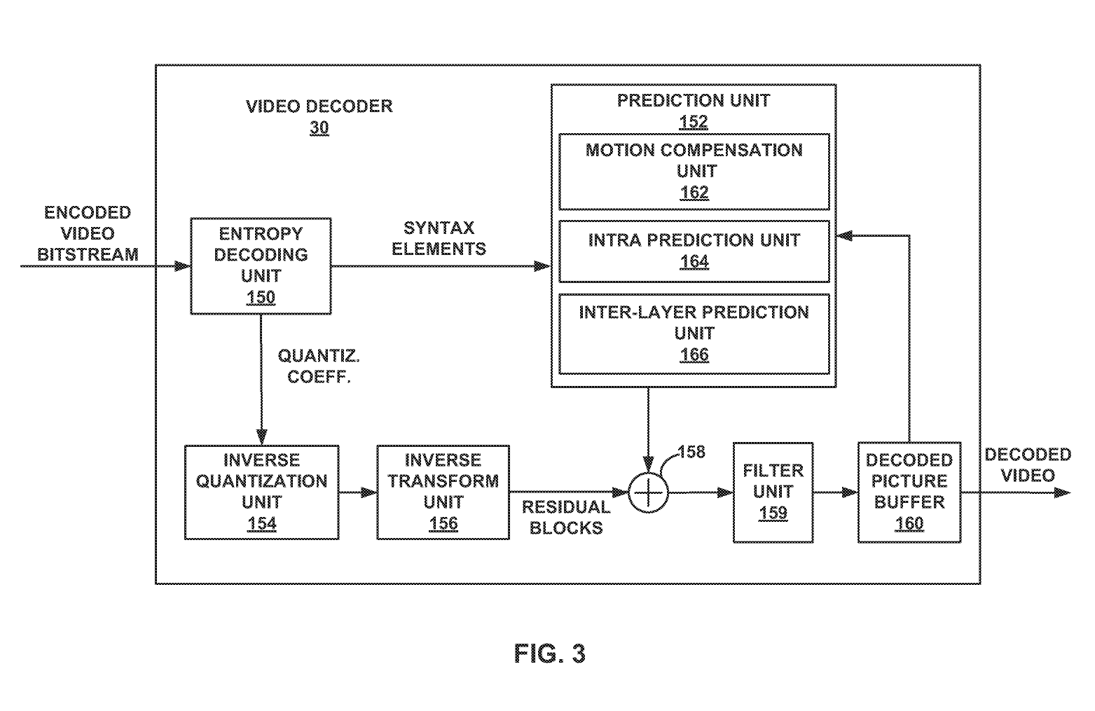

FIG. 3 is a block diagram illustrating an example of a video decoder that may implement techniques in accordance with aspects described in this disclosure. Video decoder 30 may be configured to perform any or all of the techniques of this disclosure. As one example, motion compensation unit 162 and/or intra prediction unit 164 may be configured to perform any or all of the techniques described in this disclosure. In one embodiment, video decoder 30 may optionally include inter-layer prediction unit 166 that is configured to perform any or all of the techniques described in this disclosure. In other embodiments, inter-layer prediction can be performed by prediction unit 152 (e.g., motion compensation unit 162 and/or intra prediction unit 164), in which case the inter-layer prediction unit 166 may be omitted. However, aspects of this disclosure are not so limited. In some examples, the techniques described in this disclosure may be shared among the various components of video decoder 30. In some examples, in addition to or instead of, a processor (not shown) may be configured to perform any or all of the techniques described in this disclosure.

In the example of FIG. 3, video decoder 30 includes a plurality of functional components. The functional components of video decoder 30 include an entropy decoding unit 150, a prediction unit 152, an inverse quantization unit 154, an inverse transform unit 156, a reconstruction unit 158, a filter unit 159, and a decoded picture buffer 160. Prediction unit 152 includes a motion compensation unit 162, an intra prediction unit 164, and an inter-layer prediction unit 166. In some examples, video decoder 30 may perform a decoding pass generally reciprocal to the encoding pass described with respect to video encoder 20 of FIG. 2. In other examples, video decoder 30 may include more, fewer, or different functional components.

Video decoder 30 may receive a bitstream that comprises encoded video data. The bitstream may include a plurality of syntax elements. When video decoder 30 receives the bitstream, entropy decoding unit 150 may perform a parsing operation on the bitstream. As a result of performing the parsing operation on the bitstream, entropy decoding unit 150 may extract syntax elements from the bitstream. As part of performing the parsing operation, entropy decoding unit 150 may entropy decode entropy encoded syntax elements in the bitstream. Prediction unit 152, inverse quantization unit 154, inverse transform unit 156, reconstruction unit 158, and filter unit 159 may perform a reconstruction operation that generates decoded video data based on the syntax elements extracted from the bitstream.

As discussed above, the bitstream may comprise a series of NAL units. The NAL units of the bitstream may include video parameter set NAL units, sequence parameter set NAL units, picture parameter set NAL units, SEI NAL units, and so on. As part of performing the parsing operation on the bitstream, entropy decoding unit 150 may perform parsing operations that extract and entropy decode sequence parameter sets from sequence parameter set NAL units, picture parameter sets from picture parameter set NAL units, SEI data from SEI NAL units, and so on.

In addition, the NAL units of the bitstream may include coded slice NAL units. As part of performing the parsing operation on the bitstream, entropy decoding unit 150 may perform parsing operations that extract and entropy decode coded slices from the coded slice NAL units. Each of the coded slices may include a slice header and slice data. The slice header may contain syntax elements pertaining to a slice. The syntax elements in the slice header may include a syntax element that identifies a picture parameter set associated with a picture that contains the slice. Entropy decoding unit 150 may perform entropy decoding operations, such as CABAC decoding operations, on syntax elements in the coded slice header to recover the slice header.

As part of extracting the slice data from coded slice NAL units, entropy decoding unit 150 may perform parsing operations that extract syntax elements from coded CUs in the slice data. The extracted syntax elements may include syntax elements associated with transform coefficient blocks. Entropy decoding unit 150 may then perform CABAC decoding operations on some of the syntax elements.

After entropy decoding unit 150 performs a parsing operation on a non-partitioned CU, video decoder 30 may perform a reconstruction operation on the non-partitioned CU. To perform the reconstruction operation on a non-partitioned CU, video decoder 30 may perform a reconstruction operation on each TU of the CU. By performing the reconstruction operation for each TU of the CU, video decoder 30 may reconstruct a residual video block associated with the CU.

As part of performing a reconstruction operation on a TU, inverse quantization unit 154 may inverse quantize, e.g., de-quantize, a transform coefficient block associated with the TU. Inverse quantization unit 154 may inverse quantize the transform coefficient block in a manner similar to the inverse quantization processes proposed for HEVC or defined by the H.264 decoding standard. Inverse quantization unit 154 may use a quantization parameter QP calculated by video encoder 20 for a CU of the transform coefficient block to determine a degree of quantization and, likewise, a degree of inverse quantization for inverse quantization unit 154 to apply.

After inverse quantization unit 154 inverse quantizes a transform coefficient block, inverse transform unit 156 may generate a residual video block for the TU associated with the transform coefficient block. Inverse transform unit 156 may apply an inverse transform to the transform coefficient block in order to generate the residual video block for the TU. For example, inverse transform unit 156 may apply an inverse DCT, an inverse integer transform, an inverse Karhunen-Loeve transform (KLT), an inverse rotational transform, an inverse directional transform, or another inverse transform to the transform coefficient block. In some examples, inverse transform unit 156 may determine an inverse transform to apply to the transform coefficient block based on signaling from video encoder 20. In such examples, inverse transform unit 156 may determine the inverse transform based on a signaled transform at the root node of a quadtree for a treeblock associated with the transform coefficient block. In other examples, inverse transform unit 156 may infer the inverse transform from one or more coding characteristics, such as block size, coding mode, or the like. In some examples, inverse transform unit 156 may apply a cascaded inverse transform.

In some examples, motion compensation unit 162 may refine the predicted video block of a PU by performing interpolation based on interpolation filters. Identifiers for interpolation filters to be used for motion compensation with sub-sample precision may be included in the syntax elements. Motion compensation unit 162 may use the same interpolation filters used by video encoder 20 during generation of the predicted video block of the PU to calculate interpolated values for sub-integer samples of a reference block. Motion compensation unit 162 may determine the interpolation filters used by video encoder 20 according to received syntax information and use the interpolation filters to produce the predicted video block.

As further discussed below with reference to FIGS. 8 and 9, the prediction unit 152 may code (e.g., encode or decode) the PU (or any other enhancement layer blocks or video units) by performing the methods illustrated in FIGS. 8 and 9. For example, motion compensation unit 162, intra prediction unit 164, or inter-layer prediction unit 166 may be configured to perform the methods illustrated in FIGS. 8 and 9, either together or separately.

If a PU is encoded using intra prediction, intra prediction unit 164 may perform intra prediction to generate a predicted video block for the PU. For example, intra prediction unit 164 may determine an intra prediction mode for the PU based on syntax elements in the bitstream. The bitstream may include syntax elements that intra prediction unit 164 may use to determine the intra prediction mode of the PU.

In some instances, the syntax elements may indicate that intra prediction unit 164 is to use the intra prediction mode of another PU to determine the intra prediction mode of the current PU. For example, it may be probable that the intra prediction mode of the current PU is the same as the intra prediction mode of a neighboring PU. In other words, the intra prediction mode of the neighboring PU may be the most probable mode for the current PU. Hence, in this example, the bitstream may include a small syntax element that indicates that the intra prediction mode of the PU is the same as the intra prediction mode of the neighboring PU. Intra prediction unit 164 may then use the intra prediction mode to generate prediction data (e.g., predicted samples) for the PU based on the video blocks of spatially neighboring PUs.

As discussed above, video decoder 30 may also include inter-layer prediction unit 166. Inter-layer prediction unit 166 is configured to predict a current block (e.g., a current block in the EL) using one or more different layers that are available in SVC (e.g., a base or reference layer). Such prediction may be referred to as inter-layer prediction. Inter-layer prediction unit 166 utilizes prediction methods to reduce inter-layer redundancy, thereby improving coding efficiency and reducing computational resource requirements. Some examples of inter-layer prediction include inter-layer intra prediction, inter-layer motion prediction, and inter-layer residual prediction. Inter-layer intra prediction uses the reconstruction of co-located blocks in the base layer to predict the current block in the enhancement layer. Inter-layer motion prediction uses motion information of the base layer to predict motion in the enhancement layer. Inter-layer residual prediction uses the residue of the base layer to predict the residue of the enhancement layer. Each of the inter-layer prediction schemes is discussed below in greater detail.

Reconstruction unit 158 may use the residual video blocks associated with TUs of a CU and the predicted video blocks of the PUs of the CU, e.g., either intra-prediction data or inter-prediction data, as applicable, to reconstruct the video block of the CU. Thus, video decoder 30 may generate a predicted video block and a residual video block based on syntax elements in the bitstream and may generate a video block based on the predicted video block and the residual video block.

After reconstruction unit 158 reconstructs the video block of the CU, filter unit 159 may perform a deblocking operation to reduce blocking artifacts associated with the CU. After filter unit 159 performs a deblocking operation to reduce blocking artifacts associated with the CU, video decoder 30 may store the video block of the CU in decoded picture buffer 160. Decoded picture buffer 160 may provide reference pictures for subsequent motion compensation, intra prediction, and presentation on a display device, such as display device 32 of FIG. 1. For instance, video decoder 30 may perform, based on the video blocks in decoded picture buffer 160, intra prediction or inter prediction operations on PUs of other CUs.

### Structures of Scalable Video Coding (SVC)

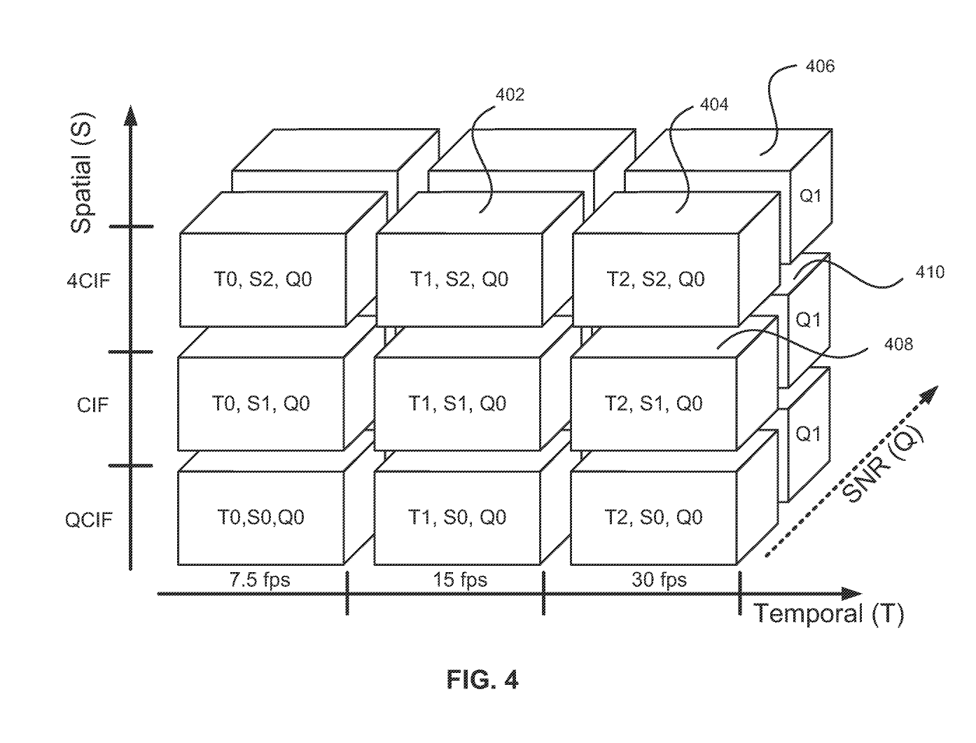

FIG. 4 is a conceptual diagram showing example scalabilities in different dimensions. As discussed above, the scalable video coding extension (SVC) of HEVC allows video information to be provided in layers. Each layer can provide video information corresponding to a different scalability. In HEVC, scalabilities are enabled in three dimensions: temporal (or time) scalability, spatial scalability, and quality scalability (sometimes referred to as signal-to-noise ratio or SNR scalability). For example, in the time dimension, frame rates with 7.5 Hz, 15 Hz, 30 Hz, and etc. can be supported by temporal scalability (T). When spatial scalability (S) is supported, different resolutions such as QCIF, CIF, 4CIF, and etc. may be enabled. For each specific spatial resolution and frame rate, the SNR (Q) layers can be added to improve the picture quality.

Once video content has been encoded in such a scalable way, an extractor tool may be used to adapt the actual delivered content according to application requirements, which can depend, for example, on the clients or the transmission channel. In the example shown in FIG. 4, each cubic contains the pictures with the same frame rate (temporal level), spatial resolution and SNR layers. For example, cubes 402 and 404 contain pictures having the same resolution and SNR, but different frame rates. Cubes 402 and 406 represent pictures having the same resolution (e.g., in the same spatial layer), but different SNRs and frame rates. Cubes 402 and 408 represent pictures having the same SNR (e.g., in the same quality layer), but different resolutions and frame rates. Cubes 402 and 410 represent pictures having different resolutions, frame rates, and SNRs. Better representation can be achieved by adding those cubes (pictures) in any dimension. Combined scalability is supported when there are two, three or even more scalabilities enabled. For example, by combining the pictures in cube 402 with those in cube 404, a higher frame rate may be realized. By combining the pictures in cube 404 with those in cube 406, a better SNR may be realized.

According to the SVC specification, the pictures with the lowest spatial and quality layer are compatible with H.264/AVC, and the pictures at the lowest temporal level form the temporal base layer, which can be enhanced with pictures at higher temporal levels. In addition to the H.264/AVC compatible layer, several spatial and/or SNR enhancement layers can be added to provide spatial and/or quality scalabilities. SNR scalability is also referred as quality scalability. Each spatial or SNR enhancement layer itself may be temporally scalable, with the same temporal scalability structure as the H.264/AVC compatible layer. For one spatial or SNR enhancement layer, the lower layer it depends on is also referred as the base layer of that specific spatial or SNR enhancement layer.

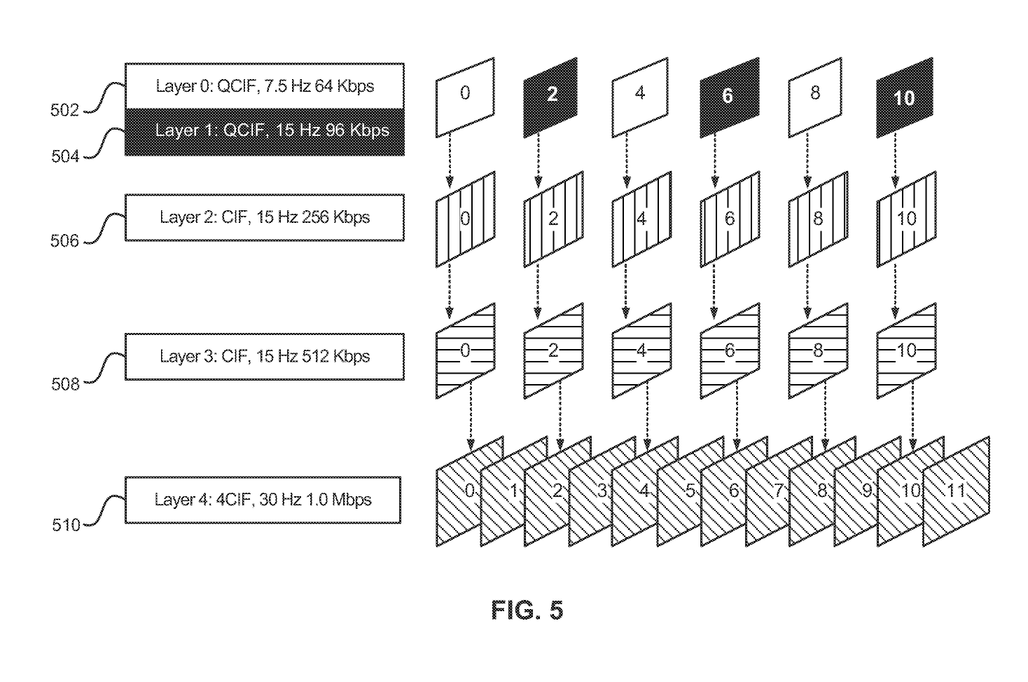

FIG. 5 is a conceptual diagram showing an example scalable video coded bitstream. In the example SVC coding structure shown in FIG. 5, the pictures with the lowest spatial and quality layer (pictures in layer 502 and layer 504, which provide QCIF resolution) are compatible with H.264/AVC. Among them, those pictures of the lowest temporal level form the temporal base layer 502, as shown in FIG. 5. This temporal base layer (e.g., layer 502) can be enhanced with pictures of higher temporal levels, such as layer 504. In addition to the H.264/AVC compatible layer, several spatial and/or SNR enhancement layers can be added to provide spatial and/or quality scalabilities. For example, an enhancement layer may be a CIF representation having the same resolution as layer 506. In the example shown in FIG. 5, layer 508 is a SNR enhancement layer. As shown in the example, each spatial or SNR enhancement layer itself may be temporally scalable, with the same temporal scalability structure as the H.264/AVC compatible layer. Also, an enhancement layer can enhance both spatial resolution and frame rate. For example, layer 510 provides a 4CIF enhancement layer, which further increases the frame rate from 15 Hz to 30 Hz.

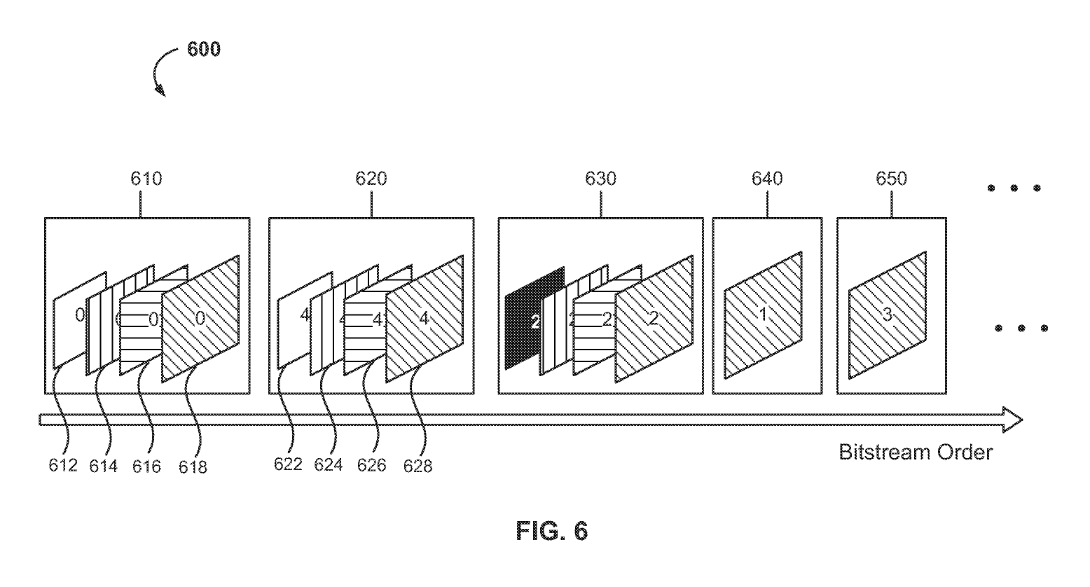

FIG. 6 is a conceptual diagram showing example access units (e.g., coded picture made up of one or more slices) in a scalable video coded bitstream 600. As shown in FIG. 6, in some embodiments, the coded slices in the same time instance are successive in the bitstream order and form one access unit in the context of SVC. Those SVC access units then follow the decoding order, which could be different from the display order. The decoding order may be decided, for example, by the temporal prediction relationship. For example, access unit 610 consisting of all four layers 612, 614, 616, and 618 for frame 0 (e.g., for frame 0 as illustrated in FIG. 5) may be followed by access unit 620 consisting of all four layers 622, 624, 626, and 628 for frame 4 (e.g., for frame 4 in FIG. 5). Access unit 630 for frame 2 may follow out of order, at least from a video playback perspective. However, information from frames 0 and 4 may be used when encoding or decoding frame 2, and therefore frame 4 can be encoded or decoded prior to frame 2. Access units 640 and 650 for the remaining frames between frames 0 and 4 may follow, as shown in FIG. 6.

Some functionalities of SVC may be inherited from H.264/AVC. Compared to previous scalable standards, many aspects of SVC, such as hierarchical temporal scalability, inter-layer prediction, single-loop decoding, and flexible transport interface, may be inherited from H.264/AVC. Each of these aspects of SVC is described in more detail below.

### Features of Scalable Video Coding (SVC)

Single-Loop Decoding

In order to achieve a low-complexity decoder, single-loop decoding is used in SVC. With single-loop decoding, each supported layer can be decoded with a single motion compensation loop. To achieve this, the usage of inter-layer intra-prediction is only allowed for enhancement layer blocks (e.g., macroblocks, CUs, PUs, etc.) for which the co-located reference layer signal is intra-coded. In some embodiments, all layers that are used to inter-layer predict higher layers may be coded using constrained intra-prediction (CIP) (e.g., intra-coded without referring to any samples from neighboring inter-coded blocks) to achieve single-loop decoding.

Inter-Layer Prediction

SVC introduces inter-layer prediction for spatial and SNR scalabilities based on texture, residue, and motion. Spatial scalability in SVC can be generalized to any resolution ratio between two layers. SNR scalability can be realized by Coarse Granularity Scalability (CGS) or Medium Granularity Scalability (MGS). In SVC, two spatial or CGS layers belong to different dependency layers (indicated by dependency_id in NAL unit header), while two MGS layers can be in the same dependency layer. One dependency layer includes quality layers with quality_id from 0 to higher values, corresponding to quality enhancement layers. In SVC, inter-layer prediction methods are utilized to reduce inter-layer redundancy, as discussed below.

One of the inter-layer prediction schemes is inter-layer intra prediction. The coding mode using inter-layer intra prediction is called “IntraBL” mode in SVC. In one embodiment, to enable single-loop decoding, only the enhancement layer blocks (e.g., macroblocks, PUs, CUs, or any other video units) that have co-located blocks in the base layer coded as constrained intra modes, can use inter-layer intra prediction mode. As discussed above, a constrained intra mode block is a block that is intra-coded without referring to any samples from neighboring inter-coded blocks.

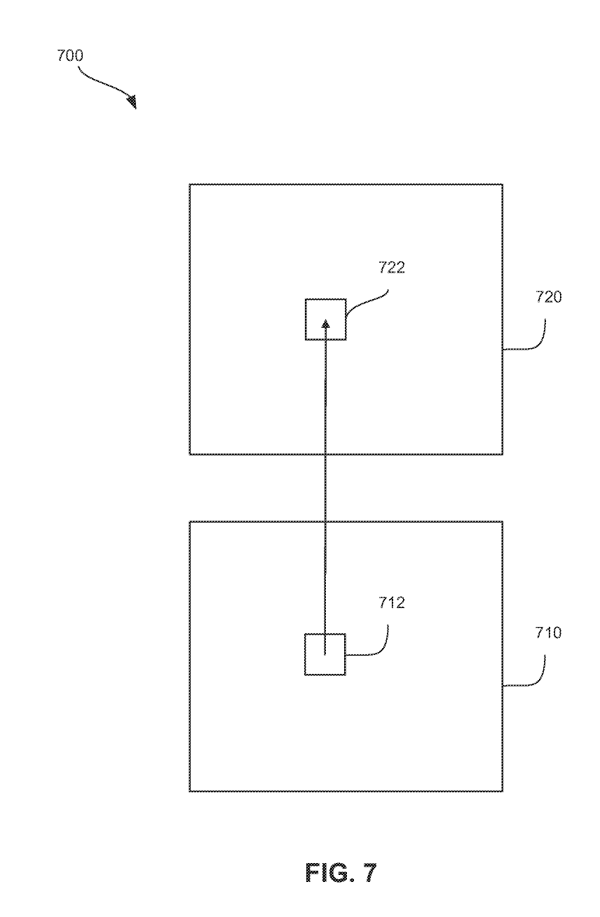

FIG. 7 illustrates a schematic of an example 700 of Intra-BL prediction. In particular, a base layer block 712 in a base layer 710 is co-located with an enhancement layer block 722 in an enhancement layer 720. In Intra-BL mode, the texture of block 722 can be predicted using the texture of the co-located base layer block 712. For example, it is possible that pixel values of the co-located base layer block 712 and the pixel values of the enhancement layer block 722 are very similar to each other, since the co-located base layer block 712 essentially depicts the same video object as the enhancement layer block 722. Thus, the pixel values of the co-located base layer block 712 may serve as a predictor for predicting the pixel values of the enhancement layer block 722. The base layer block 712 may be upsampled before being used to predict the enhancement layer block 722 if the enhancement layer 720 and the base layer 710 have different resolutions. For example, the base layer picture may be 1280×720 and the enhancement layer may be 1920×1080, in which case the base layer block or the base layer picture may be upsample by a factor of 1.5 in each direction (e.g., horizontal and vertical) before being used to predict the enhancement layer block or picture. The prediction error (e.g., residue) may be transformed, quantized and entropy encoded. The term “co-located” may be used herein to describe the position of the base layer block that depicts the same video object as the enhancement layer block. Alternatively, the term may mean that the co-located base layer block may have the same coordinate values (after the resolution ratio between the base layer and the enhancement layer is taken into account) as the enhancement layer block. Although the term “co-located” is used in this disclosure, similar techniques can be applied with neighboring (e.g., adjacent) blocks of the current block, neighboring (e.g., adjacent) blocks of the co-located block of the current block, or any other related blocks.

Another approach for inter-layer texture prediction may involve the use of an inter-layer reference picture (ILRP). In such example, a reconstructed base layer picture is inserted (after necessary up-sampling) into the reference picture list of the corresponding enhancement layer picture. The inter-layer texture prediction is achieved when the enhancement layer is predicted using the inter-layer reference picture.

### Scalability

In some existing video coding schemes, only spatial, temporal and quality (may also be called SNR) scalability designs may be available. However, the scalability can also be extended in other directions, such as color space/color gamut scalability and/or bit-depth scalability.

For example, color space may refer to a mathematical model for describing the way colors can be represented as tuples of numbers (e.g., 3 color components in RGB for red, green, and blue), and color gamut may refer to the subset of colors which can be represented in a given color space. Thus, color space scalability is present when a base layer (BL) video signal is in a different color space than an enhancement layer (EL) video signal. For example, the BL video signal may be in BT.709 (e.g., high-definition) color space, and the EL video signal may be in BT.2020 (e.g., ultra-high-definition) color space. As discussed above, a video decoder may decode just the BL of a scalable bitstream or decode the combination of the BL and EL to produce a higher quality video signal. In some embodiments, the different color spaces may be used to accommodate legacy devices that may not be configured to, for example, decode video bitstreams coded in newer color spaces. Thus, by using SVC to generate a scalable bitstream that contains a base layer that can be decoded by a legacy decoder (e.g., BT.709) to produce a video content in one color space (e.g., BT.709), and one or more enhancement layers that can be decoded by a scalable decoder to produce a video content in another color space (e.g., BT.2020), backwards compatibility with legacy decoders may be provided, and the bandwidth requirements compared with simulcasting separate bitstreams may be reduced, thereby improving the coding efficiency and performance.

Similarly, bit-depth scalability refers to the cases in which the bit depth of a base layer video signal is different from the bit depth of an enhancement layer video. For example, the BL video signal may have a bit depth of 8, and the EL video signal may have a bit depth of 10. Thus, by using SVC to generate a scalable bitstream that contains a base layer that can be decoded by a legacy decoder (e.g., 8-bit) to produce a video content having a lower bit depth (e.g., 8-bit), and one or more enhancement layers that can be decoded by a scalable decoder to produce a higher bid-depth video content (e.g., 10-bit), backwards compatibility with legacy decoders may be provided, and the bandwidth requirements compared with simulcasting separate bitstreams may be reduced, thereby improving the coding efficiency and performance.

### Inter-Layer Prediction and Color Space Scalability

In the case of color space scalability, since the color spaces used in the BL and EL are different, the same color may have different color representations (e.g., color components) in the two layers. In other words, a pixel in the EL may have different values (e.g., color component values such as Y, Cr, and Cb in the YCbCr color space) compared to the corresponding pixel in the BL (even if there is no compression error involved). Thus, when the color spaces used in the two layers are different, if the BL pixel's value is directly used to predict the EL pixel, there may be a large prediction error and the compression efficiency will be limited.

In this disclosure, a pixel representation using 3 color components is used to explain some of the embodiments discussed herein. However, this disclosure is not limited to such example, and the techniques discussed herein may be applied to other color schemes using any number of color components. For example, some color spaces may use fewer components (e.g., 1) or more components (e.g., 4). One of the most popular 3-component color representation schemes is YCbCr, where Y is corresponding to luminance values, and Cb and Cr are corresponding to chrominance values (e.g., blue and red, respectively). This disclosure describes certain embodiments using YCbCr. However, embodiments of this disclosure are not limited to YCbCr, but can also be applied to other color representations like RGB.

As discussed above, the BL video signal may be in a different color space than the EL video signal. In such a case, greater coding efficiency may be achieved by, instead of directly using the BL pixel value to predict EL pixel value, applying a prediction function to the BL pixel value before using the BL pixel value to predict the EL pixel value. The prediction function may be linear or non-linear.

The prediction process according to an example embodiment of the present disclosure is now described. Let Pel_{BL}=[Y_{bl}, Cb_{bl}, Cr_{bl}]^{T} be a pixel in BL and Pred_{EL}=[Y_{elpred}, Cb_{elpred}, Cr_{elpred}]^{T} be the predicted pixel value in EL, where T denotes transpose. The prediction function may be written as:

Pred_{EL}=W*Pel_{BL}+S (1)

where W is a 3×3 matrix with coefficients wᵢⱼ (i, j=0, 1, and 2) and S=[s₀, s₁, s₂]^{T} is a vertical offset vector. W represents the weight applied to the base layer pixel values, and S represents the offset added to the weighted base layer pixel values. In some embodiments, W and S may be called color space prediction parameters (or simply, prediction parameters).

In some embodiments, the above example may be further simplified by assuming that only the diagonal elements (w₀₀, w₁₁, and w₂₂) have non-zero values. In such embodiments, the prediction becomes:

Y_{elpred}=w₀₀*Y_{bl}+s₀ (2)

Cb_{elpred}=w₁₁*Cb_{bl}+s₁ (3)

Cr_{elpred}=w₂₂*Cr_{bl}+s₂ (4)

In some embodiments, the usage of this color transformation between layers is indicated and controlled by one or more flags. For example, there may be a flag for each color component (Y, Cb, and Cr, in the above example) for indicating whether color transformation is to be performed for the corresponding color component. These flags, for example, can be signaled in a bitstream at least at a certain level such as sequence parameter set (SPS), picture parameter set (PPS), and slice header.

FIG. 8 is a flowchart illustrating a method 800 for coding video information, according to an embodiment of the present disclosure. The steps illustrated in FIG. 8 may be performed by an encoder (e.g., the video encoder as shown in FIG. 2), a decoder (e.g., the video decoder as shown in FIG. 3), or any other component. For convenience, method 800 is described as performed by a coder, which may be the encoder, the decoder or another component.

The method 800 begins at block 801. In block 805, the coder determines predicted pixel information by applying a prediction function to pixel information of the BL block co-located with the current block in the EL. For example, pixel information may refer to pixel values or color components of such pixel values, and the predicted pixel information may refer to the predictor for determining the pixel values or color components of the EL block. In one embodiment, the prediction pixel information may be determined by applying a prediction function configured to convert pixel values in one color space to pixel values in another color space to the pixel information of the base layer. In block 810, the coder determines the current block in the EL using the predicted pixel information. For example, such process may involve subtracting the prediction value(s) obtained by applying the prediction function to the BL pixel value(s) from the actual value(s) of the EL block, and transmitting the residual and the prediction. The method 800 ends at block 815.

As discussed above, one or more components of video encoder 20 of FIG. 2 or video decoder 30 of FIG. 3 may be used to implement any of the techniques discussed in the present disclosure, such as determining the predicted pixel information, and determining the current block in the EL using the predicted pixel information.

### Prediction Using Base Layer Pixel Value

As discussed above, for an EL block coded in Intra BL mode, the pixel value (e.g., Y, Cb, and Cr) of the EL block is predicted using the corresponding (e.g., co-located) BL pixel value. Some coding modes (such as, for example, difference domain intra/inter prediction, generalized residue prediction, weighted average of temporal/intra prediction and Intra-BL prediction) may use combined prediction wherein only part of the prediction is generated using Intra BL methods. Embodiments and techniques discussed in the present disclosure may still apply to such coding modes.

### Signaling of Prediction Parameters

In one embodiment, the color space prediction parameters (e.g., w₀₀, w₁₁, w₂₂, s₀, s₁, and s₂ in the example discussed above) may be signaled for each Intra-BL unit. Using the prediction parameters, the predicted pixel value may be determined from the reconstructed BL pixel values. For example, as discussed in the example above, Equations (2)-(4) may be applied to the reconstructed BL pixel values to calculate the prediction of the pixel values of the current block in the EL. Such a process may be performed by either the encoder or the decoder, or both.

In some embodiments, the signaling of prediction parameters is done at the same level as the Intra-BL flag signaling level. In other embodiments, the signaling of prediction parameters is done at another level that is different from the Intra-BL flag signaling level. For example, it can be done at the LCU level, or the group of blocks level, or it can be signaled for a tile, a slice, a picture, or it can be signaled using high-level syntax, such as PPS or SPS.

### Quantization or Grouping of Prediction Parameters

In some embodiments, instead of transmitting the prediction parameter values as discussed above, the prediction parameters may be quantized or grouped, and only the index/indices may be transmitted. Further, the method of quantization or grouping may be signaled using a high-level syntax. Alternatively, the method of quantization or grouping may be pre-defined and known to both the encoder and the decoder.

For example, the color space prediction parameters may take values between 0 and 1000. Thus, to signal each prediction parameter, many bits are used (e.g., 10 bits to represent 1000). Thus, in such cases, the color space prediction parameters may be quantized and/or grouped together to reduce signaling costs, and only the index or indices may be transmitted to the decoder (or used to reconstruct the enhancement layer block). For example, in some embodiments, it may be determined that instead of signaling the original prediction parameter values that ranges from 0 to 1000, signaling quantized prediction parameters of 0, 100, 200, . . . , 900, and 1000 may be sufficiently accurate. In such cases, quantization indices 0, 1, and 2 may correspond to color space prediction parameters 0, 100, and 200, respectively. Thus, the signaling cost can be reduced.

### Prediction Parameters for Subset of Color Components

In some embodiments, color space prediction parameters may be transmitted for all the color components (e.g., 3 in the example above). In other embodiments, the prediction parameters are only transmitted for a subset of the color components. For example, in the YCbCr representation discussed in the example above, the prediction parameters may be signaled only for the Cr component, and not for the Y or Cb components. The definition of this subset may be signaled using high-level syntax.

### Adaptive Enabling of Prediction Parameter Transmission

In some embodiments, the color space prediction techniques discussed herein may be applied to all enhancement layer blocks coded (e.g., encoded or decoded) in Intra BL mode. In other embodiments, the transmission of color space parameters may be adaptively enabled based on side information related to the EL block, co-located BL block, or EL or BL in general. In other words, whether color space prediction parameters should be transmitted may be determined based on side information, which may include, but is not limited to, color space, color format (4:2:2, 4:2:0, etc.), frame size, frame type, prediction mode, inter-prediction direction, intra prediction mode, coding unit (CU) size, maximum/minimum coding unit size, quantization parameter (QP), maximum/minimum transform unit (TU) size, maximum transform tree depth reference frame index, temporal layer id, and etc. For example, the prediction parameters (or quantization/group indices thereof) may be transmitted only for units larger than a threshold size.

FIG. 9 is a flowchart illustrating a method 900 for coding video information, according to an embodiment of the present disclosure. The method illustrated in FIG. 9 may be performed by an encoder (e.g., the video encoder as shown in FIG. 2), a decoder (e.g., the video decoder as shown in FIG. 3), or any other component. For convenience, method 900 is described as performed by a coder, which may be the encoder, the decoder or another component.

The method 900 begins at block 901. In block 905, the coder determines whether the EL block size is greater than a threshold size. Although EL block size is used in the example of FIG. 9, any other side information, including those listed above, may be used for enabling the transmission of the prediction parameters. If the coder determines that the EL block size is greater than the threshold size, the coder transmits color space prediction parameters for the EL block in block 910. If the coder determines that the EL block size is smaller than or equal to the threshold size, the coder determines the color space prediction parameters, in block 915, based on BL pixel values or prediction parameters of previously coded blocks in the EL or BL. In block 920, the coder determines predicted pixel information of the EL block based on the prediction parameters determined in block 915. In block 925, the coder determines the EL block based on the predicted pixel information. The method 900 ends at block 930.

The order in which the steps in the method 900 are performed is not limited to that shown in FIG. 9. For example, the transmission of the color space prediction parameters for the EL block (block 910 of FIG. 9) may be performed after the prediction of the current block in the EL (block 925 of FIG. 9).

As discussed above, one or more components of video encoder 20 of FIG. 2 or video decoder 30 of FIG. 3 may be used to implement any of the techniques discussed in the present disclosure, such as determining whether the EL block size is greater than a threshold size, transmitting the color space prediction parameters, determining the color space prediction parameters, determining the predicted pixel information of the EL block, and determining the EL block based on the predicted pixel information.

Derivation of Prediction Parameters from Pixel Values

In some embodiments, instead of being transmitted, prediction parameters may be determined as a function of the values of the pixels in base layer picture. In one embodiment, the function is a constant function for each color component. In another embodiment, the function is a piece-wise linear function. For example, in the YCbCr color space, for Cr components within the range [a0, a1], the weight w₂₂ may be a and the offset s₂ may be b, and for Cr components within the range [a1, a2], the weight w₂₂ may be c and the offset s₂ may be d. The boundaries of each segment (e.g., a0, a1, and a2 in the example above) can be different for different color components. In addition, the boundaries of each segment can be different for W and S. In some embodiments, the boundary values are pre-defined and known by the encoder and the decoder. In other embodiments, the boundary values are transmitted. In some embodiments, the boundary values are adaptively derived based on side information (e.g., color space, color format, frame size, frame type, prediction mode, inter-prediction direction, intra prediction mode, CU size, maximum/minimum coding unit size, QP, maximum/minimum TU size, maximum transform tree depth reference frame index, temporal layer id, and etc., as listed in the above example).

Derivation of Prediction Parameters from Other Blocks

In some embodiments, color space prediction parameters are directly transmitted. In other embodiments, the prediction parameters or quantization/grouping indices thereof may be predicted from neighboring regions (e.g., EL blocks adjacent to the current block in the EL) and only the prediction error (e.g., residue) may be transmitted. For example, in one embodiment, the prediction parameters are predicted from units or region on the top or to the left of the current EL block being coded (e.g., encoded or decoded). In some embodiments, a merge scheme can be used to indicate that the prediction parameter(s) of a particular EL block is the same as its neighbor's prediction parameter(s). For example, if the merge_left flag is 1 for a particular block, the prediction parameter(s) may be set to be the same value(s) as its left neighbor (e.g., left PU). Similarly, merge_top flag may be used to indicate that the prediction parameter(s) for the particular block is to be set to the same value(s) as its top neighbor's. The neighboring block may be chosen from any of the blocks adjacent to the current block. A similar approach may be used with another block in the same picture as the current EL block, which has already been coded. In some embodiments, the prediction parameters of the current block may be derived from a temporal candidate (e.g., an enhancement layer block in a previous frame). For example, in one embodiment, the prediction parameter value is derived from the block at a location in a previous frame corresponding to the lower right corner of the current block in the current frame. In some examples, a plurality of merge candidates (e.g., left, top left, top, top right, temporal) may be generated, and an index may be signaled to indicate which merge candidate should be used for prediction parameter derivation.

### Combined Up-Sampling, Bit-Depth Prediction, and Color Space Prediction

In some embodiments, the color space prediction discussed above may be performed in conjunction with the up-sampling that may be performed when the BL and EL have different resolutions. In other words, the prediction process may be integrated with the up-sampling process. For example, the color space prediction may be integrated into the up-sampling filter such that there is only one formula (e.g., a single process) to achieve both color space prediction and up-sampling. For example, such formula may take multiple inputs and calculate a new value that represents a value that reflects both of the up-sampling and color space prediction processes. In one embodiment, such formula may be implemented as a single matrix that is multiplied to the BL pixel values. In another embodiment, the formula may be implemented as a single matrix that is multiplied to the BL pixel values and an offset matrix that is added to the outcome of the multiplication. In yet another embodiment, the color space prediction and the up-sampling are performed as two separate stages. In some embodiments, color space prediction is performed before upsampling. In other embodiments, up-sampling is performed before color space prediction.

Similarly, the prediction can be integrated with bit-depth prediction process. For example, if the BL has a bit depth of 8 bits and the EL has a bit depth of 10 bits, then the BL pixel value can be multiplied by 4 to predict the EL pixel value. This bit-depth prediction operation can be integrated in the color space prediction process. It is also possible to integrate all three processes (color space prediction, bit-depth prediction and up-sampling) into a single process. As discussed above, the three processes may be performed in any order and are not limited to one particular order.

Derivation of Prediction Parameters from Previous Frames

In some embodiments, the prediction parameters are transmitted at a frame level, slice level, or GOP level. For example, the prediction parameters may be transmitted for every frame. In other embodiments, the prediction parameters may be derived by analyzing the previously encoded/decoded base layer and enhancement layer images. For example, after coding (e.g., encoding or decoding) frame n−1, the coder (e.g., encoder or decoder) may analyze pixel values in frame n−1 (e.g., both BL and EL), and figure out the relationship between the BL pixel values and EL pixel values (e.g., what kind of pixel conversion may be performed to predict EL pixels using BL pixels). This technique may be applied to any of the embodiments discussed herein.

### Scaling in Color Space Prediction

In some embodiments, to increase the accuracy of the color space prediction, scaling can be used in the prediction process. For example, the process shown below may be performed, wherein the shift right by Qbits is performed last:

Y_{elpred}=(w₀₀*Y_{bl}+(1<<(Qbits−1))+s₀)>>(Qbits) (5)

For example, the value of Qbits may be determined based on how much accuracy is desired. In other words, the greater the value of Qbits is, the greater the accuracy achieved in the color space prediction. In this case, w₀₀ and s₀ may have already been scaled in accordance with the value of Qbits. In one example, Qbits effectively provides a rounding offset such that the values in Equation (5) are rounded up instead of rounded down.

In some embodiments, a clipping process may be applied to the prediction shown in Equation (5) to limit the bit-range of the prediction pixels as shown:

Y_{elpred}=CLIP(w₀₀*Y_{bl}+(1<<(Qbits−1))+s₀)>>(Qbits) (6)

In this example, the value of Y_{elpred} may be clipped to a value in the range [0, (1<<bitDepth)−1] (e.g., in order to prevent overflow). For example, if the bit-depth of the EL is 10, the prediction value Y_{elpred} is clipped to the range [0, 1023]. The bit-depth may be signaled in the PPS.

### Cross-Component Prediction

In some embodiments, the number of color components in the BL and EL may be different. In such cases, a cross-component prediction may be applied. For example, if the BL pixels each only have a single Y component (e.g., monochrome) but the EL pixels are have Y, U, and V components (e.g., YUV color space), any of the Y, U, and V components may be predicted from the Y component of the BL pixels. In another example, the U and V components of the EL pixels may be predicted using the Y component of the BL pixels and the Y component of the EL pixels. If the U component is coded (e.g., encoded or decoded) before the V component, the V component may be predicted using the U component. The prediction performed may be similar to that performed for temporal prediction. The prediction may also be linear or nonlinear.

### Temporal Base Layer Frames

In any of the embodiments discussed herein, BL temporal frames may be used in addition to the co-located BL frame. Also, the techniques discussed herein may be applied to BL pixels other than those in the co-located BL frame (e.g., previous BL frames). Thus, similar techniques may be used in conjunction with difference domain coding and generalized residual prediction (e.g., using weighting factors to employ various coding techniques, such as inter prediction, inter-layer residual prediction, inter-layer intra prediction, etc., to predict the EL block).

### High Level Syntax Only (HLS-Only) Framework

For high level syntax (HLS) only framework, e.g., where any changes at low level blocks (e.g., CUs) are not allowed, the methods in the above mentioned embodiments can be applied to generate pixels of an inter-layer reference (ILR) picture using base layer data. Thereafter, ILR can be inserted into enhancement reference picture lists. Thus, BL frames can be treated as reference frames of the EL, and no other low-level changes need to be made to the coding tools. For example, the BL frame may be up-sampled, converted to EL color space, and added to the reference frame buffer of the EL. Such BL frame is treated it as a reference frame in the EL, and the prediction used can be temporal prediction mode. In some embodiments, the color space prediction parameters for color transformation between BL and EL can be signaled only with HLS syntax, for example, in at least at a certain level such as sequence parameter set (SPS), picture parameter set (PPS), and slice header.

### Weighted Prediction

As discussed above, in inter-layer texture prediction, EL pixel values may be predicted using BL pixel values, and such prediction may involve weighted prediction (e.g., as shown in Equations (1)-(4) discussed above). In weighted prediction, a flag may be used to signal whether weighted prediction is enabled or disabled, for example, for each slice. In such example, if the flag is true (e.g., has a value of 1), a second flag may be signaled for each reference frame of the current slice. If the second flag for a reference frame is true (e.g., has a value of 1), weighted prediction parameters are transmitted for that reference frame. Thus, in some prediction schemes, if the flag for signaling whether weighted prediction is to be used is enabled, a second flag is signaled for each of the reference frames of the current slice, each of such second flag indicating whether weighted prediction parameters are transmitted for the corresponding reference frame. The transmitted parameters may be converted to weight(s) and offset(s) in the decoding process (e.g., such as those discussed in connection with Equations (1)-(4)), and the prediction may be derived by weighting and/or scaling a single reference frame, or weighted averaging multiple reference frames (e.g., each reference frame may be given a different weight) and adding an offset.

Tables 1 and 2 are the syntax tables for weighted prediction from a draft of HEVC specification. The interpretation of this syntax table and the corresponding decoding process can be found in the HEVC text specification draft 10 discussed above.

TABLE 1
Syntax Table for Weighted Prediction

| | |
|---|---|
| | De- |
| | scrip- |
| slice_segment_header( ) { | tor |

. . .

{
if( ( weighted_pred_flag && slice_type = = P) ∥

( weighted_bipred_flag && slice_type = = B ) )
pred_weight_table( )

. . .
}

TABLE 2
Syntax Table for Weighted Prediction

| | | De- |
|---|---|---|
| | | scrip- |
| pred_weight_table( ) { | | tor |
| | luma_log2_weight_denom | ue(v) |
| | if( chroma_format_idc != 0 ) | |

| | |
|---|---|
| delta_chroma_log2_weight_denom | se(v) |

for( i = 0; i <= num_ref_idx_l0_active_minus1; i++ )

| | |
|---|---|
| luma_weight_l0_flag[ i ] | u(1) |

if( chroma_format_idc != 0 )

for( i = 0; i <= num_ref_idx_l0_active_minus1; i++ )

| | |
|---|---|
| chroma_weight_l0_flag[ i ] | u(1) |

for( i = 0; i <= num_ref_idx_l0_active_minus1; i++ ) {

if( luma_weight_l0_flag[ i ] ) {

| | |
|---|---|
| delta_luma_weight_l0[ i ] | se(v) |
| luma_offset_l0[ i ] | se(v) |

}
if( chroma_weight_l0_flag[ i ] )

for( j = 0; j < 2; j++ ) {

| | |
|---|---|
| delta_chroma_weight_l0[ i ][ j ] | se(v) |
| delta_chroma_offset_l0[ i ][ j ] | se(v) |

}

}
if( slice_type = = B ) {

for( i = 0; i <= num_ref_idx_l1_active_minus1; i++ )

| | |
|---|---|
| luma_weight_l1_flag[ i ] | u(1) |

if( chroma_format_idc != 0 )

for( i = 0; i <= num_ref_idx_l1_active_minus1;
i++ )

| | |
|---|---|
| chroma_weight_l1_flag[ i ] | u(1) |

for( i = 0; i <= num_ref_idx_l1_active_minus1; i++ )
{

if( luma_weight_l1_flag[ i ] ) {

| | |
|---|---|
| delta_luma_weight_l1[ i ] | se(v) |
| luma_offset_l1[ i ] | se(v) |

}
if( chroma_weight_l1_flag[ i ] )

for( j = 0; j < 2; j++ ) {

| | |
|---|---|
| delta_chroma_weight_l1[ i ][ j ] | se(v) |
| delta_chroma_offset_l1[ i ][ j ] | se(v) |

}

}

}

}

As shown in Table 1, if weighted prediction flag is signaled, pred_weight_table( ) is used to further signal additional flags in the bitstream, as shown in Table 2.

In Table 2, if luma_weight_l0_flag[i] equals 1, it indicates that weighting factors (or parameters) for the luma component of list 0 prediction using RefPicList0[i] are present (e.g., transmitted). If luma_weight_l0_flag[i] equals 0, it indicates that these weighting factors are not present (e.g., transmitted). In this example, if luma_weight_l0_flag[i] is not present, the value may be inferred to be 0.

In addition, chroma_weight_l0_flag[i] value of 1 indicates that weighting factors for the chroma prediction values of list 0 prediction using RefPicList0[i] are present, and chroma_weight_l0_flag[i] value of 0 indicates that these weighting factors are not present. If chroma_weight_l0_flag[i] is not present, the value may be inferred to be 0.

Similarly, luma_weight_l1_flag[i] and chroma_weight_l1_flag[i] values of 1 indicate that weighting factors for the luma component and the chroma component, respectively, of list 1 prediction using RefPicList1[i] are present. Conversely, luma_weight_l1_flag[i] and chroma_weight_l1_flag[i] values of 0 indicates that these weighting factors are not present. If luma_weight_l1_flag[i] or chroma_weight_l1_flag[i] is not present, the value may be inferred to be 0.

### Inter-Layer Reference Picture and Weighted Prediction

It is possible that, in some embodiments, reference frames other than ILRP do not need to perform weighted prediction. In the examples discussed above with reference to Tables 1 and 2, for reference frames that do not use weighted prediction, the second flag may be set to 0, to indicate that weighted prediction parameters are not transmitted. Thus, in some video coding schemes, if weighted prediction is enabled for the current slice (e.g., first flag having a value of 1), an enabling flag (e.g., luma_weight_l0_flag, chroma_weight_l0_flag, etc.) is transmitted for each reference frame (in each reference frame list), to indicate whether weight and offset will be transmitted for that particular reference frame.

In another embodiment, the signaling cost associated with weighted prediction may be reduced by using a more efficient approach. For example, another flag may be signaled using high level syntax (e.g., VPS, PPS, SPS, slice header, etc.). The flag may be referred to as weighted_ilrp_flag. If weighted_ilrp_flag equals 1, weighted prediction parameters are only transmitted for ILRP frames, and not for any other reference frames of the current slice. For the reference frames other than ILRP frames, the weighted prediction is inferred to be off, which means there is no need to transmit the enabling flag (e.g., second flag) or the weighted prediction parameters.

Tables 3 and 4 illustrate some example syntax tables. In this example, the weighted ILRP flag is signaled in slice header.

TABLE 3
Syntax Table for Weighted Prediction

| | |
|---|---|
| | De- |
| | scrip- |
| slice_segment_header( ) { | tor |

. . .

{

| | |
|---|---|
| weighted_ilrp_flag | u(1) |

. . .

if( ( weighted_pred_flag && slice_type = = P) ∥

( weighted_bipred_flag && slice_type = = B ) ∥
weighted_ilrp_flag)
pred_weight_table( )

. . .
}

TABLE 4
Syntax Table for Weighted Prediction

| | | De- |
|---|---|---|
| | | scrip- |
| pred_weight_table( ) { | | tor |
| | luma_log2_weight_denom | ue(v) |
| | if( chroma_format_idc != 0 ) | |

| | |
|---|---|
| delta_chroma_log2_weight_denom | se(v) |

if (weighted_ilrp_flag = = 0)
{

for( i = 0; i <= num_ref_idx_l0_active_minus1; i++ )

| | |
|---|---|
| luma_weight_l0_flag[ i ] | u(1) |

if( chroma_format_idc != 0 )

for( i = 0; i <= num_ref_idx_l0_active_minus1; i++ )

| | |
|---|---|
| chroma_weight_l0_flag[ i ] | u(1) |

}

for( i = 0; i <= num_ref_idx_l0_active_minus1; i++ ) {

if( luma_weight_l0_flag[ i ]) {

| | |
|---|---|
| delta_luma_weight_l0[ i ] | se(v) |
| luma_offset_l0[ i ] | se(v) |

}
if( chroma_weight_l0_flag[ i ])

for( j = 0; j < 2; j++ ) {

| | |
|---|---|
| delta_chroma_weight_l0[ i ][ j ] | se(v) |
| delta_chroma_offset_l0[ i ][ j ] | se(v) |

}

}
if( slice_type = = B ) {

if (weighted_ilrp_flag = = 0)

{

for( i = 0; i <= num_ref_idx_l1_active_minus1; i++ )

| | |
|---|---|
| luma_weight_l1_flag[ i ] | u(1) |

if( chroma_format_idc != 0 )

for( i = 0; i <= num_ref_idx_l1_active_minus1; i++ )

| | |
|---|---|
| chroma_weight_l1_flag[ i ] | u(1) |

}

for( i = 0; i <= num_ref_idx_l1_active_minus1; i++ ) {

if( luma_weight_l1_flag[ i ]) {

| | |
|---|---|
| delta_luma_weight_l1[ i ] | se(v) |
| luma_offset_l1[ i ] | se(v) |

}
if( chroma_weight_l1_flag[ i ])

for( j = 0; j < 2; j++ ) {

| | |
|---|---|
| delta_chroma_weight_l1[ i ][ j ] | se(v) |
| delta_chroma_offset_l1[ i ][ j ] | se(v) |

}

}

}

}

For example, a process “is ILRP(k, i)” may be used to check whether a reference picture is an inter-layer reference picture (ILRP). The process is ILRP(k, i) may return 1 if the layer id of RefPicListk[i] (e.g., ith reference picture in the reference picture list k) is equal to the layer id of the reference layer of the current layer, and 0 otherwise.

In the example of Tables 3 and 4, weighted_ilrp_flag value of 1 indicates that luma_weight_l0_flag[i], chroma_weight_l0_flag[i], luma_weight_l1_flag[i] and chroma_weight_l1_flag[i] are not present in the bitstream, and weighted_ilrp_flag value of 0 indicates that luma_weight_l0_flag[i], chroma_weight_l0_flag[i], luma_weight_l1_flag[i] (when the current slice is a B slice, e.g., slice_type is B) and chroma_weight_l1_flag[i] (when the current slice is a B slice, e.g., slice_type is B) are present in the bitstream.

If luma_weight_l0_flag[i] is not present, the value may be inferred to be 1 if weighted_ilrp_flag is 1 and RefPicList0[i] is a ILRP (e.g., is ILRP(0, i) returns 1), and otherwise inferred to be 0. Also, if chroma_weight_l0_flag[i] is not present, the value may be inferred to be 1 if weighted_ilrp_flag is 1 and RefPicList0[i] is a ILRP (e.g., is ILRP(0, i) returns 1), and otherwise inferred to be 0.

Similarly, if luma_weight_l1_flag[i] is not present, the value may be inferred to be 1 if weighted_ilrp_flag is 1 and RefPicList1[i] is a ILRP (e.g., is ILRP(1, i) returns 1), and otherwise inferred to be 0. Also, if chroma_weight_l1_flag[i] is not present, the value may be inferred to be 1 if weighted_ilrp_flag is 1 and RefPicList1[i] is a ILRP (e.g., is ILRP(1, i) returns 1), and otherwise inferred to be 0.

In the example of Table 4, the weight prediction parameters (e.g., luma_weight_l0_flag[i], chroma_weight_l0_flag[i], luma_weight_l1_flag[i], and chroma_weight_l1_flag[i]) are included in the IF clause “if (weighted_ilrp_flag==0).” In other words, the weight prediction parameters are included only if weighted ILRP is not enabled, in which case the syntax table of Table 4 becomes similar to that shown in Table 2.

In another example, weighted_ilrp_flag may be conditionally signaled (e.g., conditioned on weighted_pred_flag and/or weighted_bipred_flag), as shown in Tables 5 and 6 illustrated below. In other words, in the example of Table 5, weighted_ilrp_flag is signaled only if neither the weighted prediction flag nor the weighted biprediction flag is enabled (e.g., no regular weighted prediction or biprediction). In the example of Table 6, weighted_ilrp_flag is signaled only if at least one of the weighted prediction or weighted biprediction flags is not enabled.

TABLE 5
Syntax Table for Weighted Prediction

| | |
|---|---|
| | De- |
| | scrip- |
| slice_segment_header( ) { | tor |

. . .

{

if (weighted_pred_flag = = 0 && weighted_bipred_flag =
=0)

| | |
|---|---|
| weighted_ilrp_flag | u(1) |

. . .

if( ( weighted_pred_flag && slice_type = = P) ∥

( weighted_bipred_flag && slice_type = = B ) ∥
weighted_ilrp_flag)
pred_weight_table( )

. . .
}

TABLE 6
Syntax Table for Weighted Prediction

| | |
|---|---|
| | De- |
| | scrip- |
| slice_segment_header( ) { | tor |

. . .

{

if (weighted_pred_flag = = 0 ∥ weighted_bipred_flag = =0)

| | |
|---|---|
| weighted_ilrp_flag | u(1) |

. . .

if( ( weighted_pred_flag && slice_type = = P) ∥

( weighted_bipred_flag && slice_type = = B ) ∥
weighted_ilrp_flag)
pred_weight_table( )

. . .
}

As discussed above, a decoding process (including weighted prediction) is described in the HEVC text specification draft 10.

Information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC). Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of inter-operative hardware units, including one or more processors as described above, in conjunction with suitable software and/or firmware.

Various embodiments of the invention have been described. These and other embodiments are within the scope of the following claims.

What is claimed is:

1. An apparatus configured to code video information, the apparatus comprising:
a memory unit configured to store video information associated with a base layer and an enhancement layer, the enhancement layer comprising an enhancement layer (EL) block and the base layer comprising a base layer (BL) block that is co-located with the enhancement layer block; and
a processor in communication with the memory unit, the processor configured to:
determine predicted pixel information of the EL block by applying a prediction function to pixel information of the BL block; and
determine the EL block using the predicted pixel information.

2. The apparatus of claim 1, wherein the apparatus comprises an encoder, and wherein the processor is further configured to encode the EL block using the predicted pixel information.

3. The apparatus of claim 1, wherein the apparatus comprises a decoder, and wherein the processor is further configured to decode the EL block using the predicted pixel information.

4. The apparatus of claim 1, wherein the apparatus comprises a device selected from a group consisting one or more of computers, notebooks, laptops, computers, tablet computers, set-top boxes, telephone handsets, smart phones, smart pads, televisions, cameras, display devices, digital media players, video gaming consoles, and in-car computers.

5. The apparatus of claim 1, wherein the processor is configured to apply a combined up-sampling and prediction filter to the pixel information of the BL block, the combined up-sampling and prediction filter configured to up-sample the pixel information of the BL block based on a resolution ratio of the base layer and the enhancement layer and to determine the predicted pixel information of the EL block based on the up-sampled pixel information of the BL block.

6. The apparatus of claim 1, wherein the processor is configured to add a rounding offset to one or more pixel values when applying the prediction function to the pixel information of the BL block, and to clip the one or more pixel values to a bit range of the predicted pixel information.

7. The apparatus of claim 1, wherein the number of one or more color components used to represent a BL pixel is different from the number of one or more color components used to represent an EL pixel, and the processor is configured to determine at least one of said one or more color components of the EL pixel based on another one of said one or more color components of the EL pixel.

8. The apparatus of claim 1, wherein the processor is configured to determine the predicted pixel information of the EL block by applying the prediction function to pixel information of another base layer block that is in a frame that is temporally adjacent to the frame containing the BL block.

9. The apparatus of claim 1, wherein the processor is configured to:
determine a reference frame by applying the prediction function to a base layer frame;
add the reference frame to a reference frame buffer of the enhancement layer; and
code the EL block in inter prediction using the reference frame in the reference frame buffer.

10. A method of coding video information, the method comprising:
storing video information associated with a base layer and an enhancement layer, the enhancement layer comprising an enhancement layer (EL) block and the base layer comprising a base layer (BL) block that is co-located with the enhancement layer block;
determining predicted pixel information of the EL block by applying a prediction function to pixel information of the BL block; and
determining the EL block using the predicted pixel information.

11. The method of claim 10, further comprising applying a combined up-sampling and prediction filter to the pixel information of the BL block, the combined up-sampling and prediction filter configured to up-sample the pixel information of the BL block based on a resolution ratio of the base layer and the enhancement layer and to determine the predicted pixel information of the EL block based on the up-sampled pixel information of the BL block.

12. The method of claim 10, further comprising:
adding a rounding offset to one or more pixel values when applying the prediction function to the pixel information of the BL block; and
clipping the one or more pixel values to a bit range of the predicted pixel information.

13. The method of claim 10, further comprising determining, when the number of one or more color components of a BL pixel is different from the number of one or more color components of an EL pixel, at least one of said one or more color components of the EL pixel based on another one of said one or more color components of the EL pixel.

14. The method of claim 10, further comprising determining the predicted pixel information of the EL block by applying the prediction function to pixel information of another base layer block that is in a frame that is temporally adjacent to the frame containing the BL block.

15. The method of claim 10, further comprising:
determining a reference frame by applying the prediction function to a base layer frame;
adding the reference frame to a reference frame buffer of the enhancement layer; and
coding the EL block in inter prediction using the reference frame in the reference frame buffer.

16. An apparatus configured to code video information, the apparatus comprising:
a memory unit configured to store video information associated with a base layer and an enhancement layer, the enhancement layer comprising an enhancement layer (EL) block and the base layer comprising a base layer (BL) block that is co-located with the enhancement layer block, wherein the BL block is represented in a first color space and the EL block is represented in a second color space different from the first color space; and
a processor in communication with the memory unit, the processor configured to:
determine predicted pixel information of the EL block by applying a prediction function to pixel information of the BL block, the prediction function including one or more prediction parameters configured to convert the pixel information represented in the first color space to the predicted pixel information represented in the second color space; and
determine the EL block using the predicted pixel information.

17. The apparatus of claim 16, wherein the apparatus comprises an encoder, and wherein the processor is further configured to encode the EL block using the predicted pixel information.

18. The apparatus of claim 16, wherein the apparatus comprises a decoder, and wherein the processor is further configured to decode the EL block using the predicted pixel information.

19. The apparatus of claim 16, wherein the apparatus comprises a device selected from a group consisting one or more of computers, notebooks, laptops, computers, tablet computers, set-top boxes, telephone handsets, smart phones, smart pads, televisions, cameras, display devices, digital media players, video gaming consoles, and in-car computers.

20. The apparatus of claim 16, wherein the processor is configured to transmit said one or more prediction parameters for each block in the enhancement layer.

21. The apparatus of claim 16, wherein the processor is configured to quantize said one or more prediction parameters and transmit only one or more quantization indices corresponding to said one or more prediction parameters.

22. The apparatus of claim 16, wherein the processor is configured to transmit said one or more prediction parameters for only a subset of color components used to represent the pixel information of the BL block.

23. The apparatus of claim 16, wherein the processor is configured to determine whether to transmit said one or more prediction parameters for the EL block based on non-pixel information of the EL block.

24. The apparatus of claim 16, wherein the processor is configured to determine said one or more prediction parameters based on the pixel information of the BL block, pixel information of previously coded blocks in the base layer and the enhancement layer, or one or more prediction parameters of a neighboring block in the enhancement layer that is adjacent to the EL block.

25. A method of coding video information, the method comprising:
storing video information associated with a base layer and an enhancement layer, the enhancement layer comprising an enhancement layer (EL) block and the base layer comprising a base layer (BL) block that is co-located with the enhancement layer block, wherein the BL block is represented in a first color space and the EL block is represented in a second color space different from the first color space;
determining predicted pixel information of the EL block by applying a prediction function to pixel information of the BL block, the prediction function including one or more prediction parameters configured to convert the pixel information represented in the first color space to the predicted pixel information represented in the second color space; and
determining the EL block using the predicted pixel information.

26. The method of claim 25, further comprising transmitting said one or more prediction parameters for each block in the enhancement layer.

27. The method of claim 25, further comprising:
quantizing said one or more prediction parameters; and
transmitting only one or more quantization indices corresponding to said one or more prediction parameters.

28. The method of claim 25, further comprising transmitting said one or more prediction parameters for only a subset of color components used to represent the pixel information of the BL block.

29. The method of claim 25, further comprising determining whether to transmit said one or more prediction parameters for the EL block based on non-pixel information of the EL block.

30. The method of claim 25, further comprising determining said one or more prediction parameters based on the pixel information of the BL block, pixel information of previously coded blocks in the base layer and the enhancement layer, or one or more prediction parameters of a neighboring block in the enhancement layer that is adjacent to the EL block.
